(19) United States
(12) Patent Application Publication
(10) Pub. No.: US 2015/0211482 A1
(43) Pub. Date: Jul. 30, 2015

(54) RESILIENT BLADE WIND TURBINE

(71) Applicant: Theodore Radisek, Euclid, OH (US)

(72) Inventor: Theodore Radisek, Euclid, OH (US)

(21) Appl. No.: 14/642,746

(22) Filed: Mar. 9, 2015

Related U.S. Application Data
(60) Provisional application No. 61/924,876, filed on Jan. 8, 2014.

(51) Int. Cl. F03D 1/06

(52) U.S. Cl. CPC F03D 1/0691; F03D 1/0666

(57) ABSTRACT

A turbine blade having a resilient structure including a circumferentially extended blade mounted at a leading edge to a periphery of a cylindrical turbine, and defining a neutral blade position; wherein the resilient structure is configured to permit generally radial deflection of the blade in reaction to impinging fluid flow, and to oppose the deflection with a spring force biased to the neutral blade position.

A resilient blade that produces torque in a consistent rotational direction regardless of deflection from its neutral concentric position.

A resilient blade that is cantilevered from a fixed point on a turbine periphery that is shaped with curvature concentric with the supporting turbine center.

### CROSS-REFERENCE TO RELATED APPLICATIONS

This application claims the benefit of U.S. Provisional Patent Application No. 61/924,876, filed Jan. 8, 2014 by Radisek, said application hereby incorporated in its entirety by reference herein.

### TECHNICAL FIELD OF THE INVENTION

The present invention relates to apparatus and operational method for an impeller having a specific blade structure and attachment means, more particularly, to an impulse-effected wind turbine having a circumferentially extended blade.

### BACKGROUND OF THE INVENTION

Sail rotor windmills are one of the oldest documented types of wind mill, which used flat pieces of cloth to deflect the wind for pumping water by absorbing kinetic energy from the wind. Savonious type windmills such as water wheels operate on flow drag and also harness working fluid kinetic energy. Savonious type wind turbines are regarded as less practical than today's most popular wind turbines which have a horizontal propeller axis and utilize blades based on airfoil lift. Following the oil embargo of the 1970's NASA invested capital into the development of alternative energy. NASA research results deemed the horizontal axis type wind turbine to be the most effective design configuration for investment. A vertical axis wind turbine system called the “Cyclogyro” (see FIGS. 1A-1B) existed at the time and had been documented with greater potential power coefficients as shown in FIG. 1C. However, since maintenance and dependability are key factors in wind turbine economics; the complex Cyclogyro mechanism continuously changing the airfoil blade attack angle made the Cyclogyro design appear less practical. Companies today around the globe, some aided by NASA research have made the horizontal axis wind turbine the industry standard, with tooling and processes well established. Yet the wind power industry profit margins appear so narrow that government subsidies have become a wind turbine market investment control valve. If man is to tip the global investment balance in favor of renewable energy, simpler, and more dependable large wind energy systems are desired with the objective of bringing the cost per kilowatt-hour below that of fossil fuels. Today's wind energy industry desires increased capacity potential, greater simplicity, dependability and performance to attain the goal of becoming self-sustaining.

Referring particularly to FIG. 1C, today's wind industry rates the physical performance of wind energy systems by calculating a “power coefficient” which compares energy produced to the potential energy passing through the turbine's frontal sweep area. At present, the best horizontal axis wind turbine power coefficient does not exceed 47.5% of available potential energy. This equates to 80% of the “Betz Factor” which is a theoretical limit well-known in the wind industry. The Betz Factor of 0.593 postulates that the power coefficient of horizontal axis turbines will never exceed 59.3% of the potential energy passing through the frontal sweep area.

It is an objective of our invention to introduce a less complex and more dependable turbine system with greater return on investment, i.e., a power generating wind turbine that is more cost effective because it is more efficient in converting flow field energy into available power.

### BRIEF SUMMARY OF THE INVENTION

The present application discloses one or more inventions concerning a turbine configuration with unique blade design that is simpler to construct and more cost effective in converting flow field kinetic energy into available power by dynamics that differ from that of the prior art, including, for example: horizontal axis turbine airfoil lift or Savonious turbine type airfoil drag.

In brief, the invention(s) disclosed herein concerns a novel turbine and turbine blade that has greater simplicity in its construction and can be used to improve the return on investment and improve performance of wind turbines. This is especially true for so-called vertical axis wind turbines. The new improved blade implements a new concept for driving a turbine. In other words the present invention concerns a new method and means of operation for a turbine, and thus a novel type of wind turbine.

In a preferred embodiment the present invention involves turbine blades that extend as curved cantilever beams fixed (attached) at one end to the periphery of a supporting structure. Without any applied flow field forces, the curvature of the blade is concentric to the turbine center axis. As flow field forces interact with the turbine, resilience within the turbine system allows the blades to deflect away from their concentric neutral positions resulting in applied torque and angular velocity to the turbine which can be harnessed for the generation of energy such as electricity. Whether the cantilevered blades deflect radially inward toward center or outward, the resulting direction of torque and angular velocity of the turbine system is consistent with the fixed end of the cantilevered blade leading as the blades rotate about the turbine center axis. As the blades resiliently deflect from their relaxed (neutral) concentric positions, energies can be stored internally within the blade or within the interface between the blade and turbine structure, or within the turbine structure itself. All three components have the potential of acting as springs to store potential energy derived from the kinetic energy of blade deflection. Any blade deviation from the relaxed neutral position will produce torque and resulting rotation in a single consistent rotational direction.

The best turbine structure for use with the inventive blade is a cylindrical or annular turbine structure such as a “vertical axis” type of wind turbine wherein one, or preferably a plurality of blades circumferentially extend from attachment nodes spaced apart on the periphery of the cylindrical turbine carrier structure.

The inventive blade translates kinetic energy from impacting air molecules of a fluid flow field into torque and rotational speed about the turbine center (axis of rotation). The kinetic energy of the impacting flow field molecules cause resilient deflection of the cantilevered blade in a generally radial direction (either radially inward or outward) resulting in a moment couple about turbine center. The blade rotates about the turbine center consistent with the blade attachment node being the leading edge. The plurality of the impacting flow field molecules may also be referred to as flow field pressure or also as a pressure differential between the external and internal effective blade surface. The system acts as a spring when deflected from the neutral position, translating the kinetic energies of the impacting flow field molecules into turbine torque and rotational speed.

As the turbine rotates submersed within a flow field each blade oscillates radially about a neutral blade position at a frequency equal to the rotational frequency of the turbine. Two opposing blade neutral positions exist perpendicular to two maximum effective area positions within the rotational cycle. The flow field deflects the blade farthest inward when the turbine is rotated to place the blade center at the middle of the windward half of the swept area, and deflects the blade farthest outward when it is rotated to place the blade center at the middle of the downwind half of the swept area. Blade resilience also continues to produce torque as opposing wind forces are decreasing to zero as the internal blade stresses perpetually try and return the blade back to its neutral position once at the left, and once at the right end of the swept area where the blade becomes somewhat parallel to the flow field and cannot be deflected by the wind. Thus one cycle of 360 degree turbine rotation correlates with one cycle of blade deflection from radial maximum to radial minimum, then returning to maximum. The neutral position being passed through at both radial extents of the turbine sweep area.

A variation of the inventive concept involves altering the component of most resilient flexure from the blade itself to an interface component between the blade and turbine central hub. For example, the blade may be rigid but one or a combination of several of the interface components between blade and turbine hub may instead provide resilient flexure. For example, instead of beam-type flexure, a spring biased hinge may be provided between the blade and turbine axis. For example, spring-like resilience may be advantageously distributed among two or more components of the turbine such as the blade and carrier (interface) components. Using different materials and shapes to provide resilience in different ways in different components gives the turbine designer great latitude for determining a design in which none of the components is likely to be stressed beyond its elastic limits.

As common to all turbine systems, the efficiency in energy extraction (e.g., electric power generation) from the surrounding flow field is important, yet of lesser significance as compared to the entire system cost per unit of energy produced. With both factors considered critical to overall turbine system economics, the present invention offers reduced cost per unit of energy produced with comparable efficiencies to that of prior art turbine systems.

A turbine system using our inventive spring blade turbine concept is expected to be useful as a wind or water flow field energy conversion system. The system may also be reversible for the purpose of imparting energy to a surrounding medium for such purposes as for providing lift, or thrust as a fan or propeller.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. For example, 109, 109′, and 109″ are three different versions of an element 109 which are similar or related in some way but are separately referenced for the purpose of describing modifications to the parent element (109). Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIGS. 1A, 1B and 1C show a simplified model of a prior art Cyclogyro in isometric view and perspective, respectively, and a graph comparing Cyclogyro power coefficients for different types of turbines as known in the prior art.

FIGS. 2A-2C are a top view, perspective view, and a side view, respectively, of the disclosed turbine in an embodiment that incorporates a carrier structure previously patented by the present inventor, all according to the present invention.

FIG. 3 is a perspective view of the disclosed (new) turbine showing standard turbine sweep area determinations, all according to the present invention.

FIGS. 4A-4B are side elevation and a perspective view, respectively, of a prototype embodiment of a resilient blade wind turbine (“new turbine”) before and after tilting the axis toward the approaching wind, all according to the present invention herein disclosed.

FIG. 5 is a side elevation view of a prototype embodiment of a resilient blade wind turbine with an outline of the increased frontal sweep area resulting from tilt of the turbine axis in a direction parallel to the approaching flow field.

FIG. 6 is a front elevation perspective of a prototype embodiment of a resilient blade wind turbine with an outline of the increased frontal sweep area resulting from tilt of the turbine axis into the approaching flow field.

FIG. 7 is a front elevation view of a prototype embodiment of a resilient blade wind turbine with compound tilting of the turbine axis in directions parallel and perpendicular to the approaching flow field, thus lowering the height of blades traveling upstream while simultaneously raising the height of blades traveling downstream. The change in sweep area orientation is also shown.

FIG. 8 is a perspective view outlining major elements of a turbine blade embodiment, according to the present invention.

FIG. 9 is the top view of a single blade at incremental points in cycle of turbine rotation demonstrating neutral position and general radial blade deflection with respect to the approaching wind direction.

FIG. 10 is a composite schematic top view that summarizes torque calculations detailed in FIGS. 11A-12C, all according to the present invention.

FIGS. 11A-11D—are schematic top views of a single blade portion of the disclosed turbine, each view illustrating details about the dynamic reactive blade deflection in progression at a windward most key point in the rotational cycle, all according to the present invention.

FIGS. 12A-12C are schematic top views of a single blade portion of the disclosed turbine, illustrating a progression at a downwind most key point in the rotational cycle, of dynamic blade deflection according to the present invention.

FIGS. 13A-13D are perspective views of several turbine blade shapes, providing examples of some blade design variations that are within the scope of the disclosed turbine according to the present invention.

FIG. 14 is a perspective view of a spring-biased hinge type of resilient blade according to the present invention.

FIG. 15A-15D illustrates displacement from the neutral position for several configurations of the present invention with the spring bias within different turbine key components.

FIG. 16 illustrates a blade with constant blade thickness as compared to a blade with blade taper from leading to trailing edge.

FIG. 17 is a perspective illustration of a simplified anemometer that was used in calculations comparing anemometer average static torque to the average static torque produced by the disclosed turbine.

FIGS. 18-19 are a perspective view and a top view, respectively, of a simplified model of the disclosed turbine as used in calculating static torque production according to theories of the present invention.

FIGS. 20A-20C is a top view of a single anemometer bucket and spoke showing related part numbers and variables as they are used in calculating produced static torque of the anemometer of FIG. 17.

FIGS. 21A-21D are a top view of a single blade within a simplified model of the disclosed turbine, showing related part numbers and variables as they are used in calculating produced static torque of the disclosed turbine according to the present invention.

FIGS. 22A-22C are graphic representations of calculated static torque for a single cup anemometer, all four cups and summation of static torque for all four cups respectively.

FIGS. 23A-23C are graphic representations of calculated static torque for a single blade of the simplified model of the disclosed turbine, all four blades and summation of static torque for all four blades respectively.

FIG. 24 is a graph plot of test results for the disclosed turbine, showing how the turbine peripheral speed exceeds the wind speed that drives it, all according to the present invention.

FIG. 25A-25G are illustrations of an alternative configuration of the resilient blade as a mechanical system used to store internal energy within the blade by use of a mechanical spring.

### DETAILED DESCRIPTION OF THE INVENTION

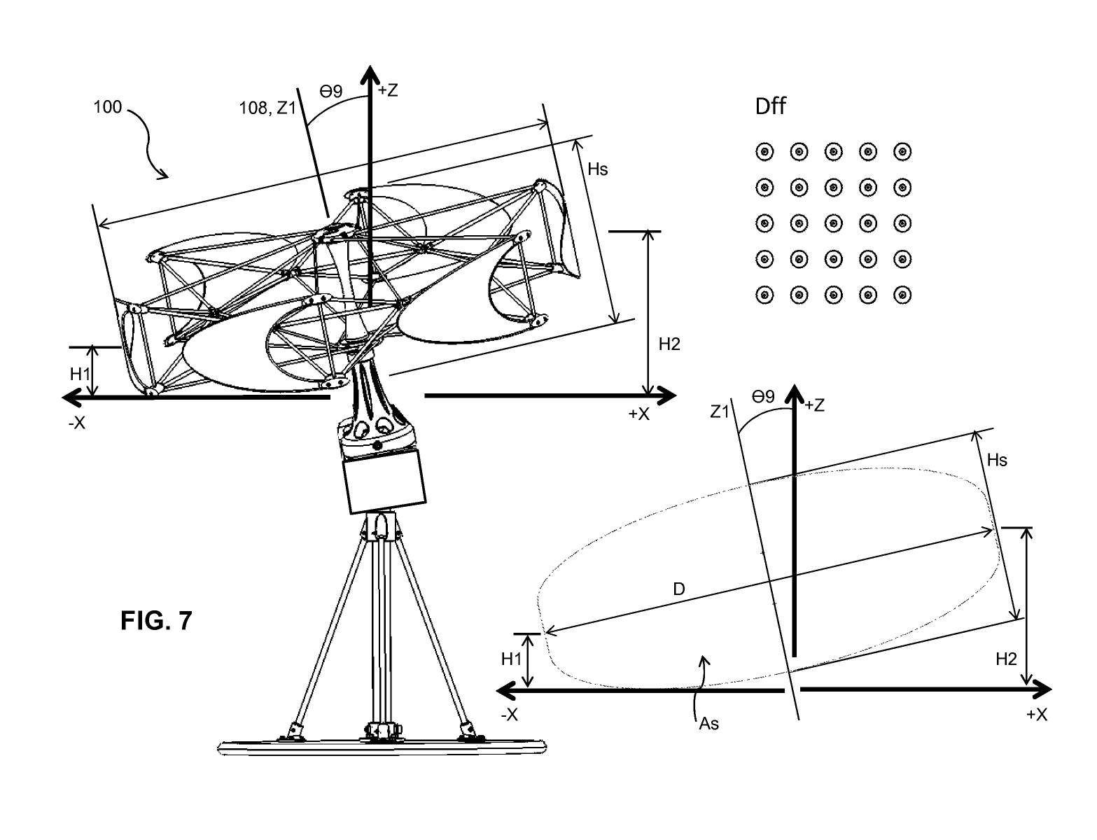

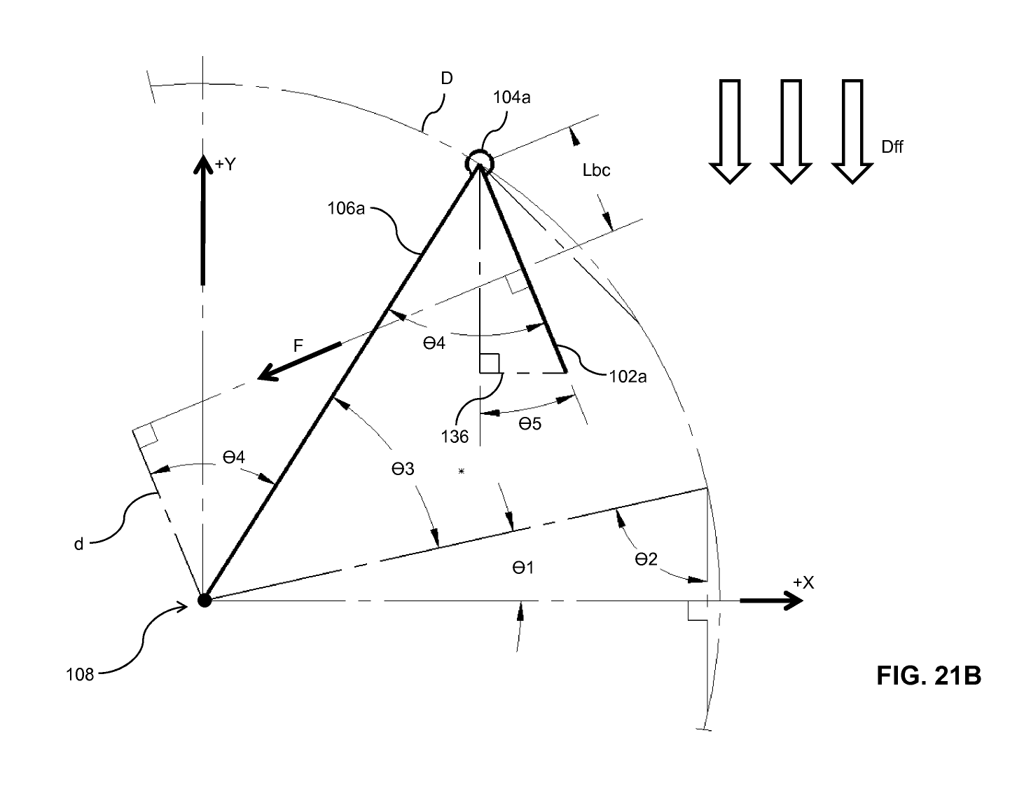

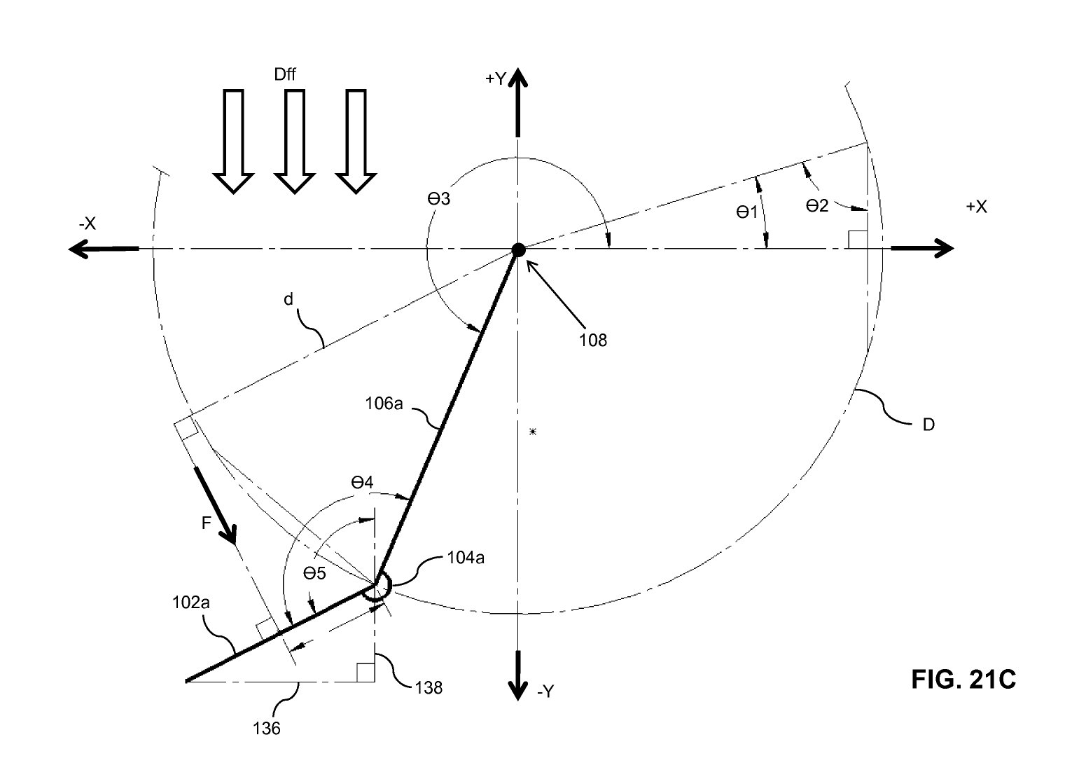

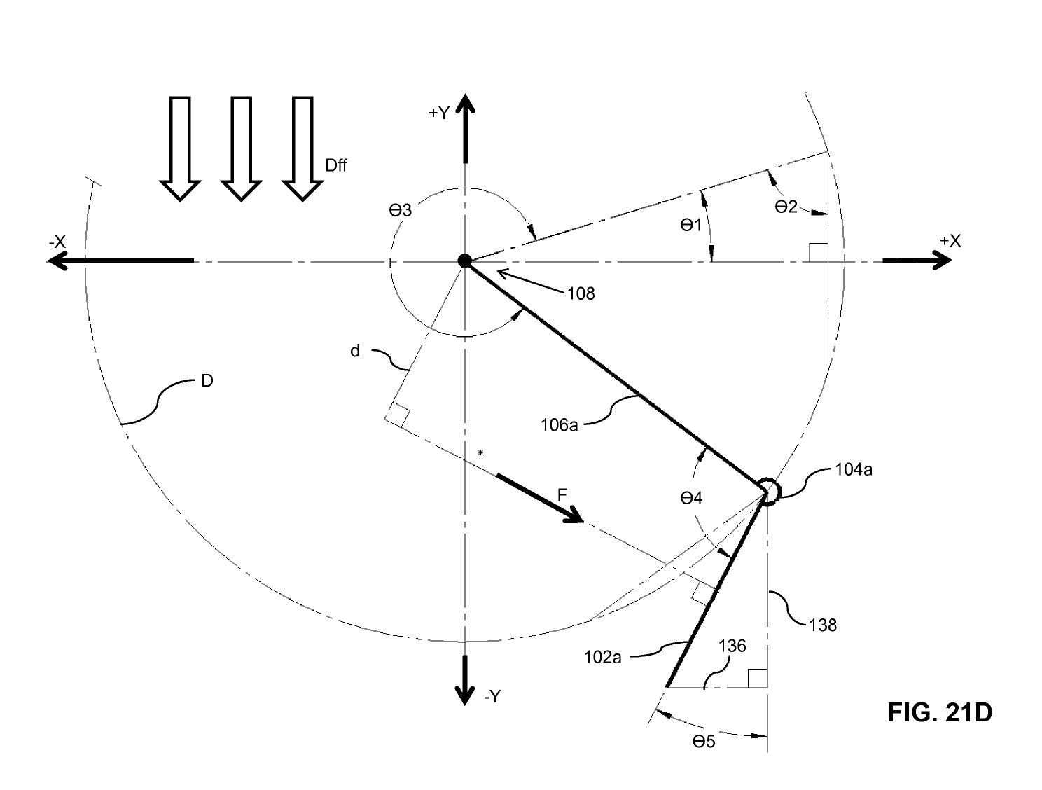

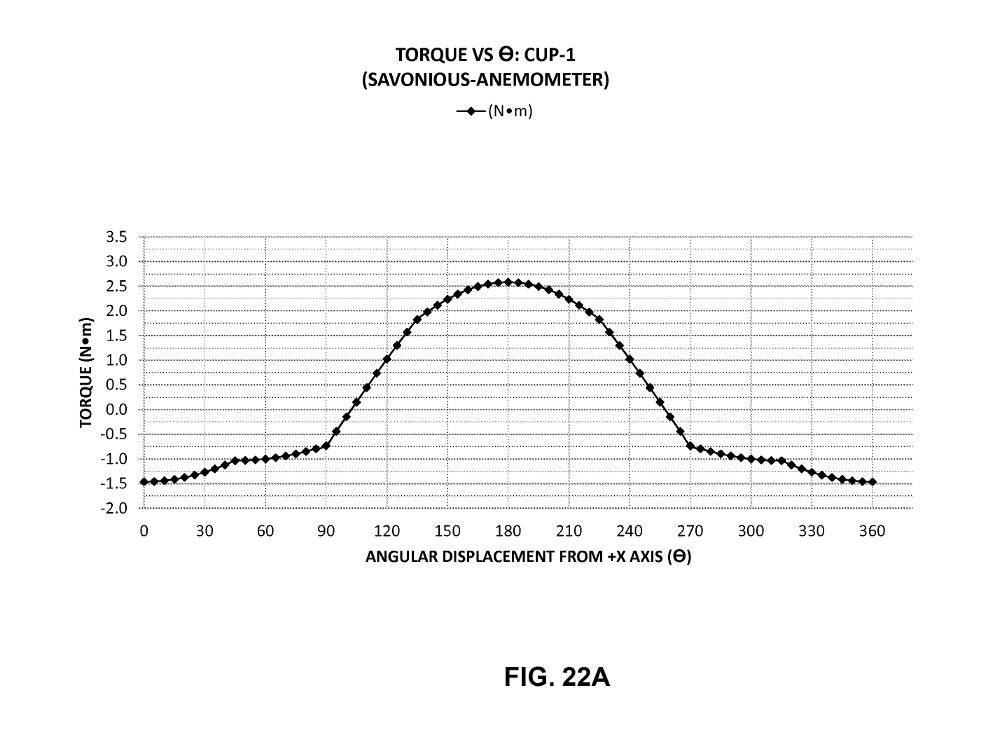

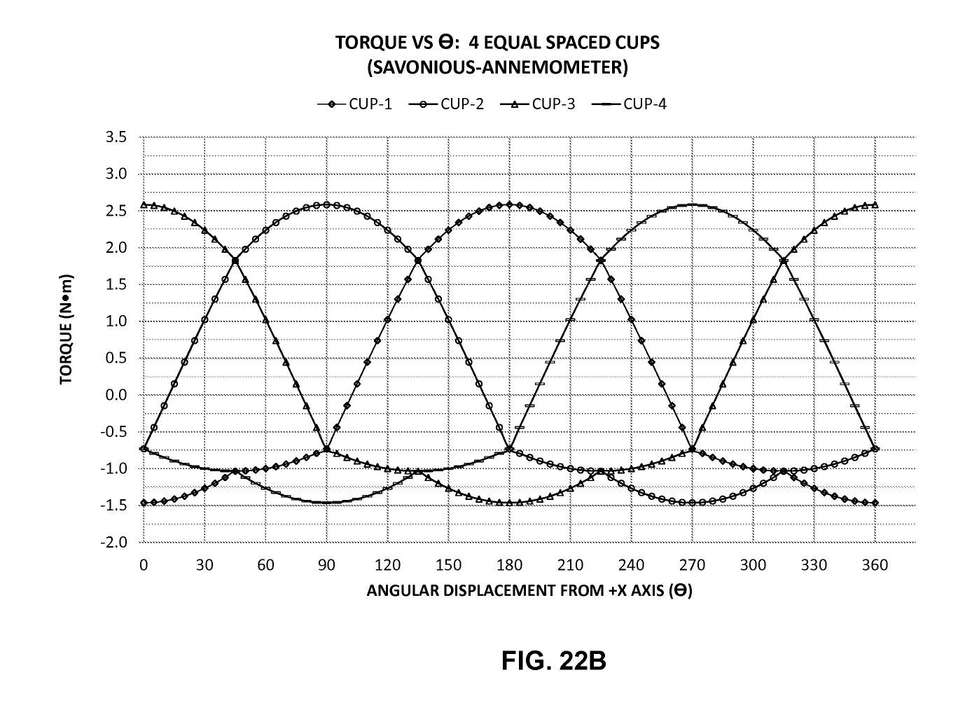

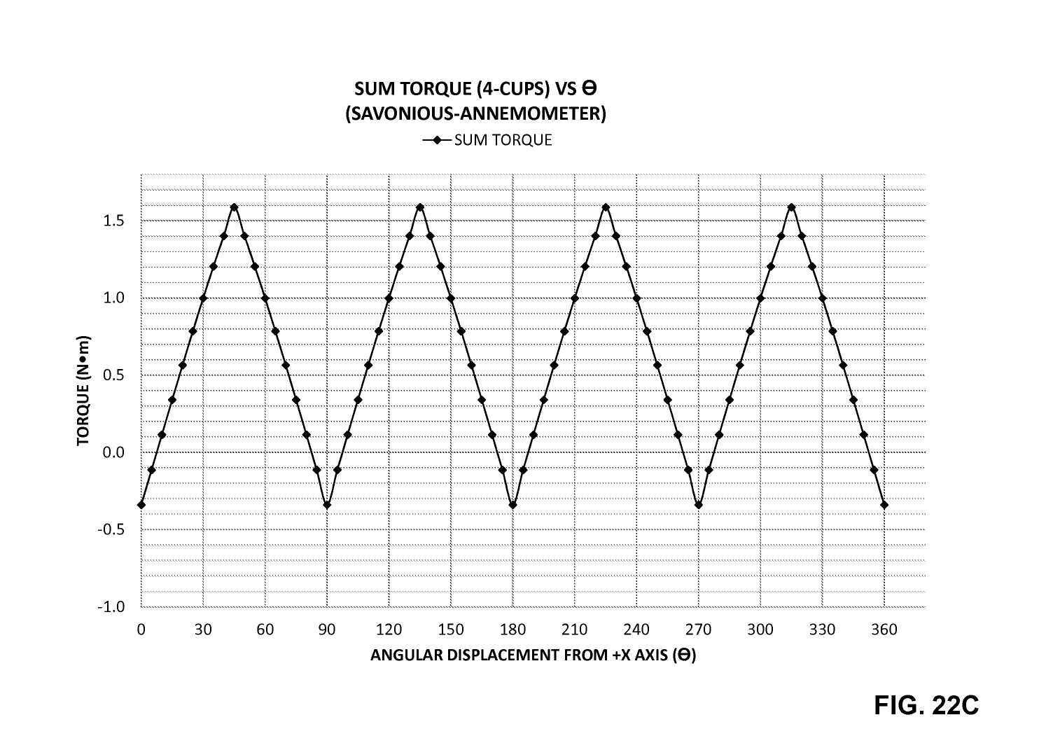

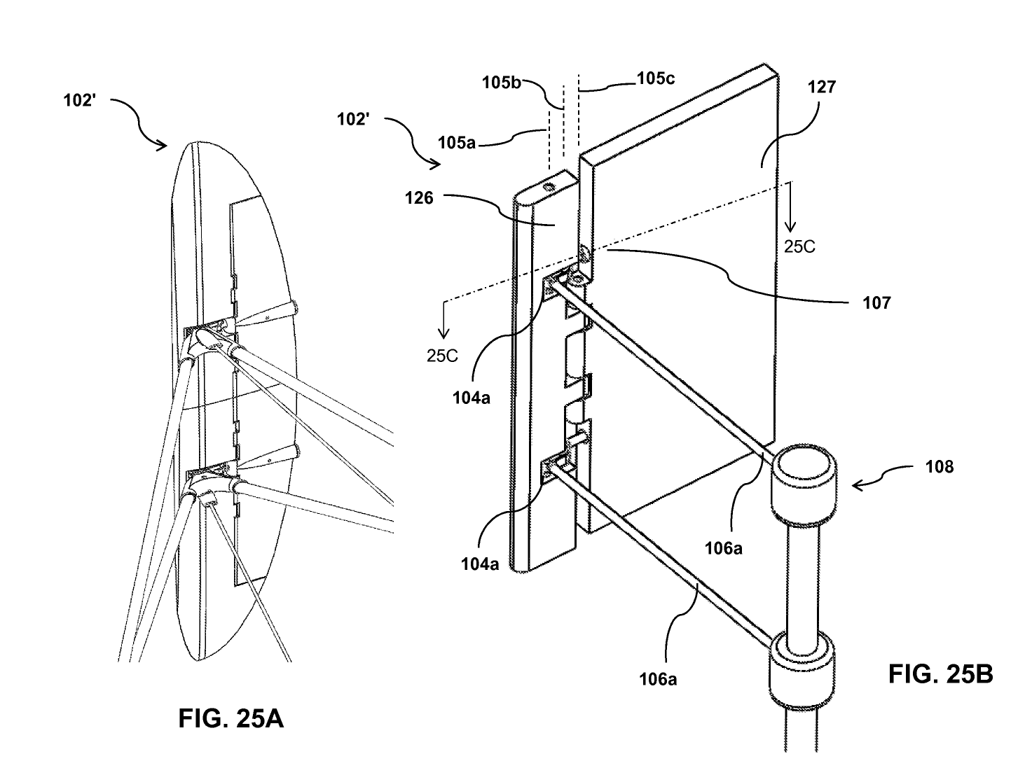

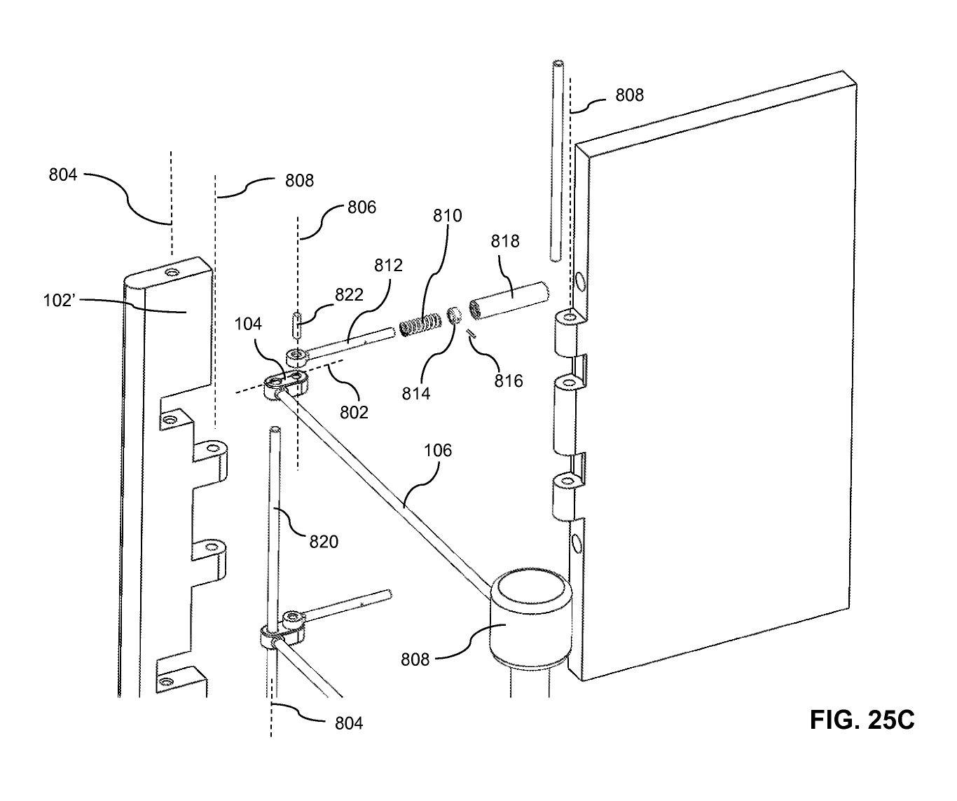

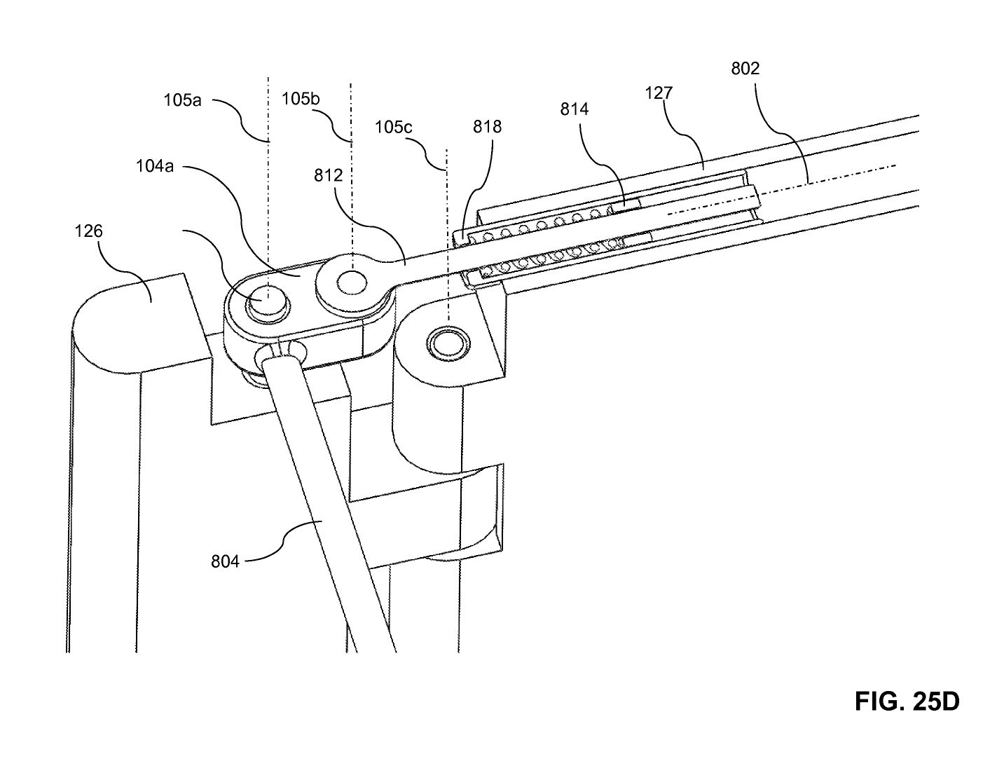

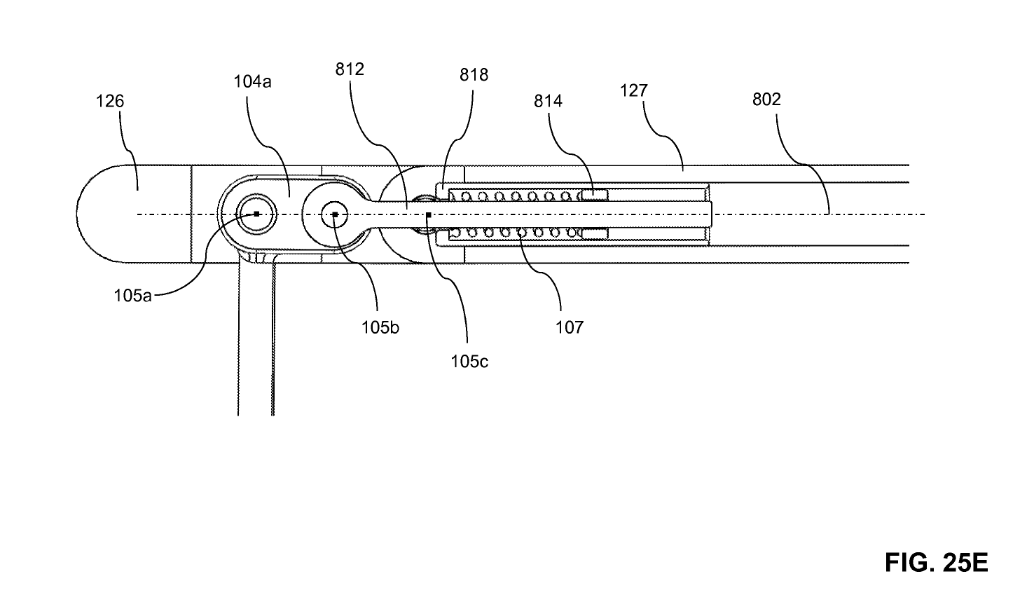

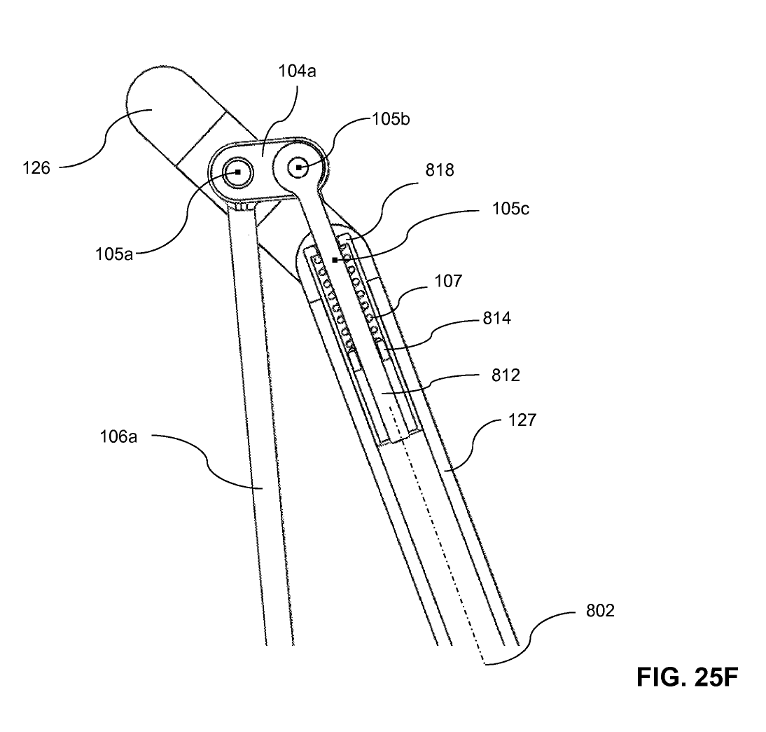

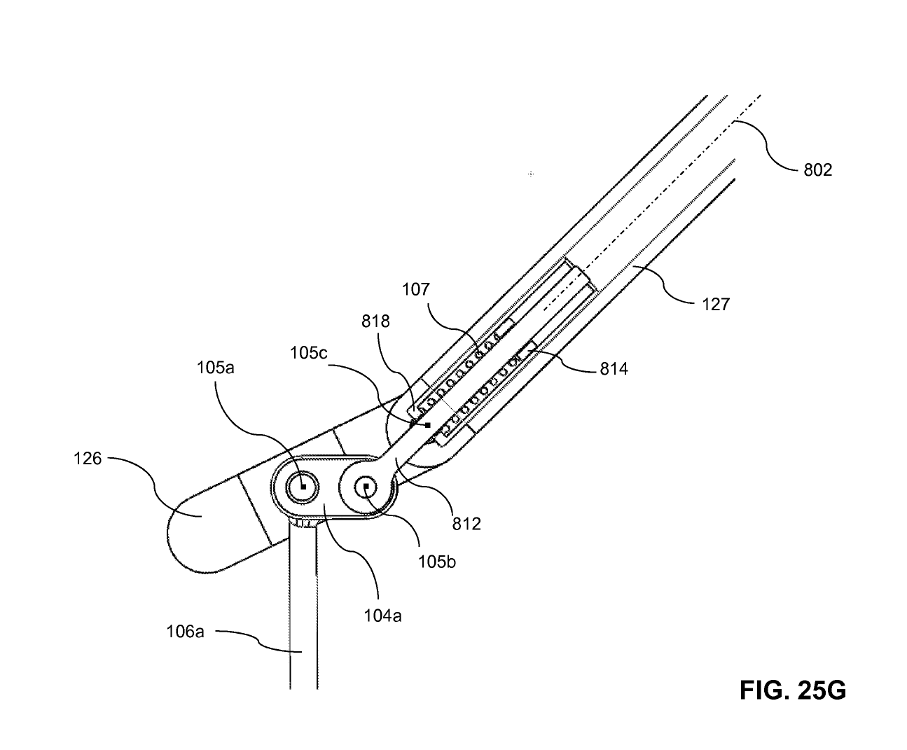

Elements of the present disclosure will be described in text with element names and terms having the following reference numbers (and symbols) used in the accompanying drawings.

| REF. NO. | DEFINITION |
|---|---|
| 100 | resilient blade wind turbine |
| 102 | blade of resilient blade wind turbine, being flexible and having resilience in a radial |
| | direction toward or away from turbine center axis 108 |
| 102a | rigid plate version of blade where effective blade resilience is provided by connected |
| | turbine components |
| 102′ | compound blade (FIGS. 25A-F) |
| 104 | node, interfacial component linking blade and turbine structure. considered rigid or |
| | with negligible flexibility/resilience |
| 104a | resilient node having mechanical spring like characteristics in the radial direction, |
| | e.g., a hinge axis 105 with a spring 107 |
| 105 | hinge axis parallel to turbine axis 108, for a hinged blade to node connection |
| 105a | compound blade 102′ first hinge/pivot axis |
| 105b | compound blade 102′ second hinge/pivot axis |
| 105c | compound blade 102′ third hinge/pivot axis |
| 106 | turbine structure. Any structure or mechanism acting as a turbine blade support |
| | structure used for transference of blade generated torques to a central axis. |
| 106a | spoke, typically rigid. Modeled as a radial bar from turbine center (axis) to a blade |
| | attachment node at turbine periphery. Is a simplified representation of the net effect |
| | physical characteristics of the turbine (carrier) structure 106 that is functionally |
| | connected to a blade 102 via its attachment node 104, thereby positioning the node at |
| | a predetermined neutral location relative to the axis 108, wherein the spoke embodies |
| | a fixed radius and rotational angle of the predetermined neutral location. |
| 106b | resilient spoke, same as 106a except with resilient flexibility. |
| 107 | spring used with blade to achieve resilience |
| 108 | turbine axle or ″hub″. Defines turbine axis of rotation = Z1 |
| 110 | blade in neutral position (e.g., stationary turbine, no wind) |
| 112 | blade at maximum upwind position |
| 114 | blade at maximum downwind position |
| 120 | external (outward facing at rest) blade surface of 102 |
| 122 | internal (inward facing at rest) blade surface of 102 |
| 124 | blade attachment area, attaches to node 104 |
| 126 | leading edge (end) of blade |
| 127 | trailing edge (end) of blade |
| 128 | blade cutout (ineffective blade area that is removed) |
| 130 | centroid of deflected blade area |
| 132 | a construction line representing the equivalent effective area Aeff equal to that of the |
| | resilient curved blade |
| 134 | force vector line of action |
| 136 | projected blade area normal to flow field direction Dff |
| 138 | line parallel to flow field direction Dff and intersecting attachment node 104 |
| 150 | turbine tower or supporting structure, ground based support of wind turbine 100 |
| 152 | pivot joint between 100 and 150 |
| 200 | model of cyclogyro turbine (prior art) |
| 202 | (cyclogyro) airfoil |
| 204 | (cyclogyro) spoke. Member supporting and connecting airfoil to turbine center axis. |
| 206 | (cyclogyro) central cam |
| 208 | (cyclogyro) blade actuation strut or linkage. Transfers cam motion to airfoil to adjust |
| | airfoil angle of attack. |
| 210 | (cyclogyro) airfoil pivot axle. Generally located at airfoil center of lift (quarter cord |
| | point). Allows airfoil attack angle to be adjusted by cam mechanism. |
| 212 | (cyclogyro) pivot-able link between 208 and 202 |
| 300 | diagram of radial deflection cycle for single blade 102a |
| 400 | blade dynamics diagram at upwind position |
| 500 | blade dynamics diagram at downwind position |
| 600 | (Savonious) anemometer model (prior art) |
| 602 | (Savonious) hollow straight sided wedge cup |
| 604 | (Savonious) spoke |
| 606 | (Savonious) internal cup wedge face |
| 608 | (Savonious) external cup wedge face |
| 610 | (Savonious) open cup face area |
| 612 | width of effective area of 606 |
| 614 | width of effective area of 608 |
| 616 | width of effective area of 610 |
| 700 | comparison model of turbine 100, using flat plate blades 102a and node type 104a |
| 702, 107 | radial spring for comparison model |
| 8xx | 800 series numbers apply to extra components of the compound resilient blade 102′ |
| 802 | axis of neutral blade, is perpendicular to turbine central axis 108 |
| 105a | blade leading edge pivot axis |
| 105b | sliding stem pivot axis |
| 105c | pivot axis between blade segments |
| 107 | spring |
| 812 | pivot stem |
| 814 | spring compression bushing |
| 816 | set pin |
| 818 | spring mechanism interface between blade segments |
| 820 | pivot pin (leading blade segment) |
| 822 | pivot pin (pivot stem) |
| 824 | bushing |
| Ab | blade single side physical surface area |
| Ac | (Savonious) open cup area |
| Aeff | projected blade area normal to flow field direction Dff |
| Awf | wedge face area |
| As | sweep area of turbine = total turbine area normal to flow field direction |
| CDc | drag coefficient for open cup face (1.35) |
| CDw | drag coefficient for wedge face (1.08) |
| d | perpendicular distance between force vector F and the turbine central axis 108 |
| da | (Savonious) moment arm distance for internal wedge face 606 |
| db | (Savonious) moment arm distance for internal wedge face 608 |
| D | diameter of turbine |
| Dff | direction of working fluid flow field = direction of approaching wind |
| F | vector of force with magnitude and direction |
| Fa | (Savonious) resulting force vector on 606 |
| Fb | (Savonious) resulting force vector on 608 |
| Fc | (Savonious) resulting force vector on open cup face 610 |
| Fw | force of approaching wind |
| Hb | height of turbine |
| Hc | (Savonious cup height) |
| Hs | height of sweep area |
| H1 | height from reference X-Y plane to central height of lowest blade. see FIG. 7 |
| H2 | height from reference X-Y plane to central height of highest blade. see FIG. 7 |
| Lb | blade length |
| Lc | (Savonious) width of open cup face 610 |
| Lw | (Savonious) width of wedge face 606 and 608 |
| Pw | dynamic flow field pressure |
| R | radius of turbine |
| Rs | radius of Savonious turbine |
| ρ | (rho) density of flow field |
| SP | starting position on new concept turbine for static torque comparison (FIG. 21A) |
| Ta | torque produced by Fa acting on Wedge face 606 |
| Tb | torque produced by Fa acting on Wedge face 608 |
| Tc | torque produced by Fa acting on Wedge face 610 |
| Vff | velocity of working flow field = velocity of approaching wind. Generally in meters |
| | per second |
| +X | axis of reference coordinate system generally perpendicular to working fluid flow |
| | direction Dff, positive side of origin, generally shown as extending to the right in the |
| | ″horizontal″ plane (above turbine frame of reference). (also see symbol definitions of |
| | X, Y, Z below) |
| −X | axis of reference coordinate system generally perpendicular to working fluid flow |
| | direction Dff, negative side of origin, generally shown as extending to the left in the |
| | ″horizontal″ plane (above turbine frame of reference). (also see symbol definitions of |
| | X, Y, Z below) |
| +Y | axis of reference coordinate system, positive side of origin, generally shown as |
| | extending forward on a plane (above turbine frame of reference with +X direction to |
| | the right). (also see symbol definitions of X, Y, Z below) |
| −Y | axis of reference coordinate system, negative side of origin, generally shown as |
| | extending rearward on a plane (above turbine-frame of reference with +X direction to |
| | the right). (also see symbol definitions of X, Y, Z below) |
| +Z | axis of reference coordinate system coincident with the turbine axis and pointing |
| | directly upward when X-Y plane is parallel to the working flow. This axis remains |
| | vertical if the X = Y plane is tilted to a non-parallel to working flow orientation |
| −Z | axis of reference coordinate system coincident with the turbine axis and pointing |
| | directly downward when X-Y plane is parallel to the working flow. This axis remains |
| | vertical if the X = Y plane is tilted to a non-parallel to working flow orientation |
| Z1 | axis of turbine main axle 108 |
| (Theta) | The following labels for angles are indicated by the Greek letter θ (Theta) followed |
| | by a distinguishing letter(s) and/or number. |
| θA | (Savonious) angular displacement of internal wedge face 606 |
| θB | (Savonious) angular displacement of external wedge face 608 |
| θC | (Savonious) angular displacement of open cup face 610 from starting position |
| θfa | (Savonious) angular displacement of Fa from +X axis |
| θfb | (Savonious) angular displacement of Fb from +X axis |
| θfc | (Savonious) angular displacement of Fc from +X axis |
| θ1 | predefined angle between the +X axis and the turbine spoke 106a when spoke is at |
| | rotational cycle starting position SP |
| θ2 | predetermined angle between spoke 106a and flat plate turbine blade 102a when |
| | blade is at neutral position at cycle starting position SP |
| θ3 | angular displacement of spoke 106a from starting position (at angle θ1) |
| θ4 | dynamic angle between spoke 106a and flat blade 102a |
| θ5 | angle between flow field direction and blade effective area 136 |
| θ8 | angle between Z1 and +Z axis on Y-Z reference plane. |
| θ9 | angle between Z1 and +Z axis on X-Z reference coordinate plane. |
| ω | (Omega) angular velocity of turbine |

Turbine Dynamics

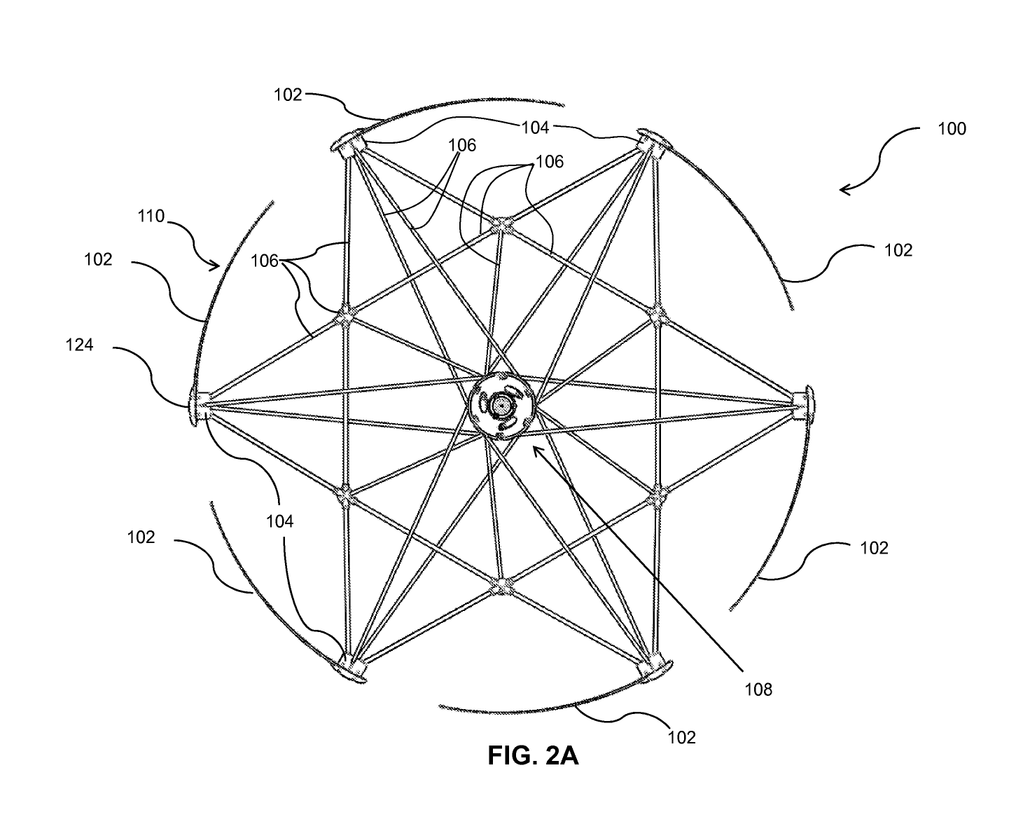

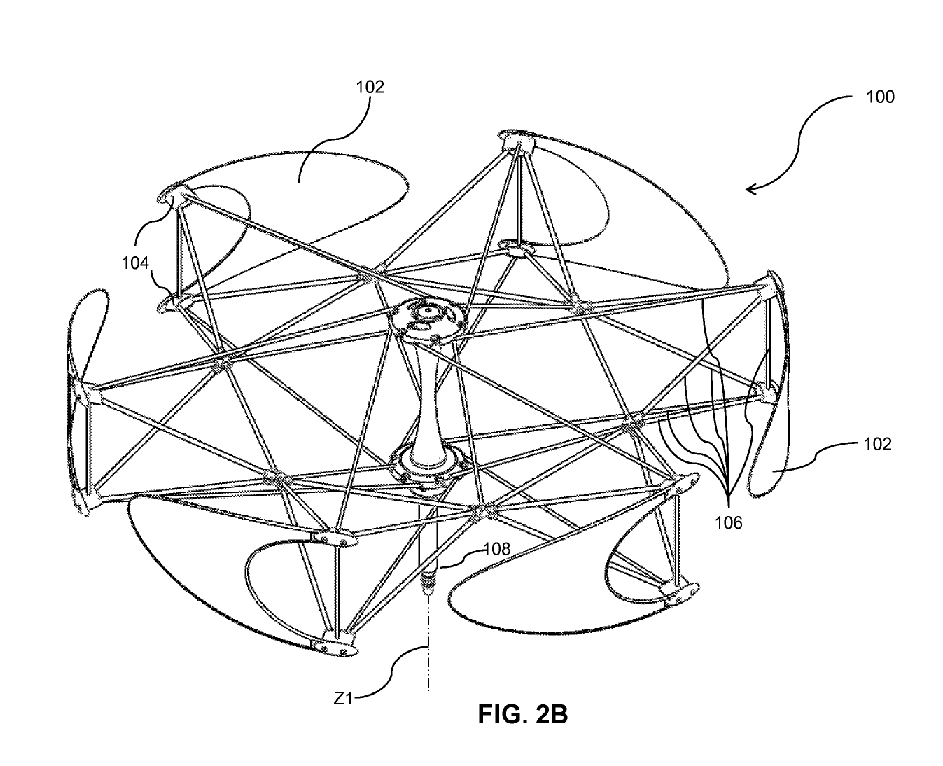

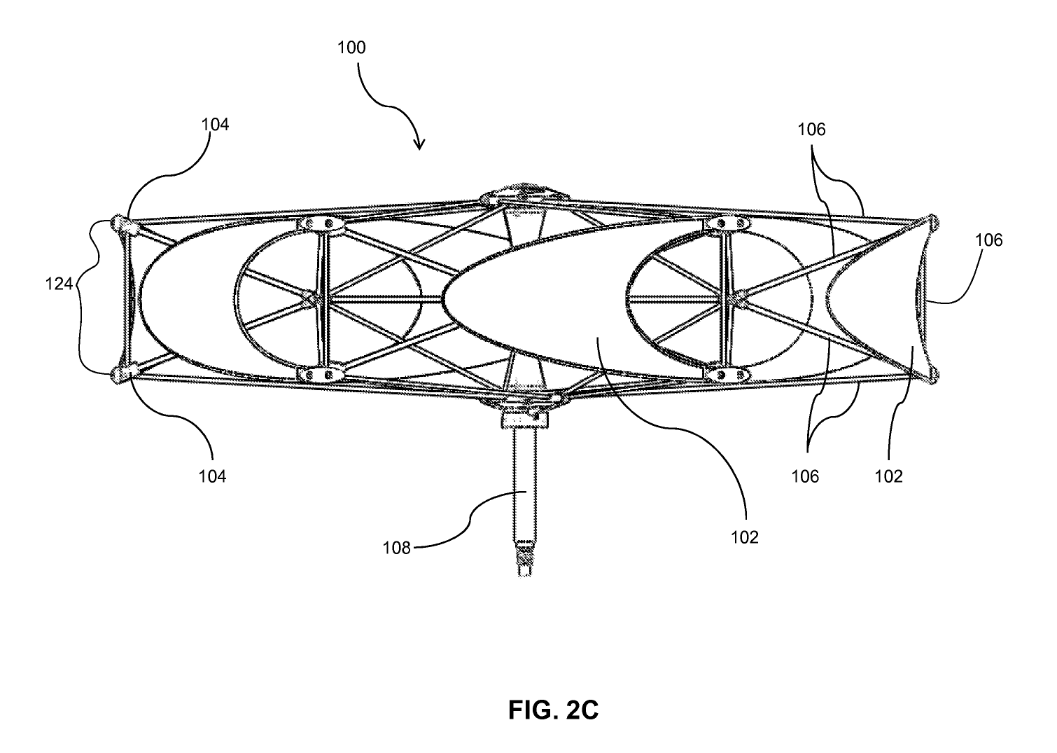

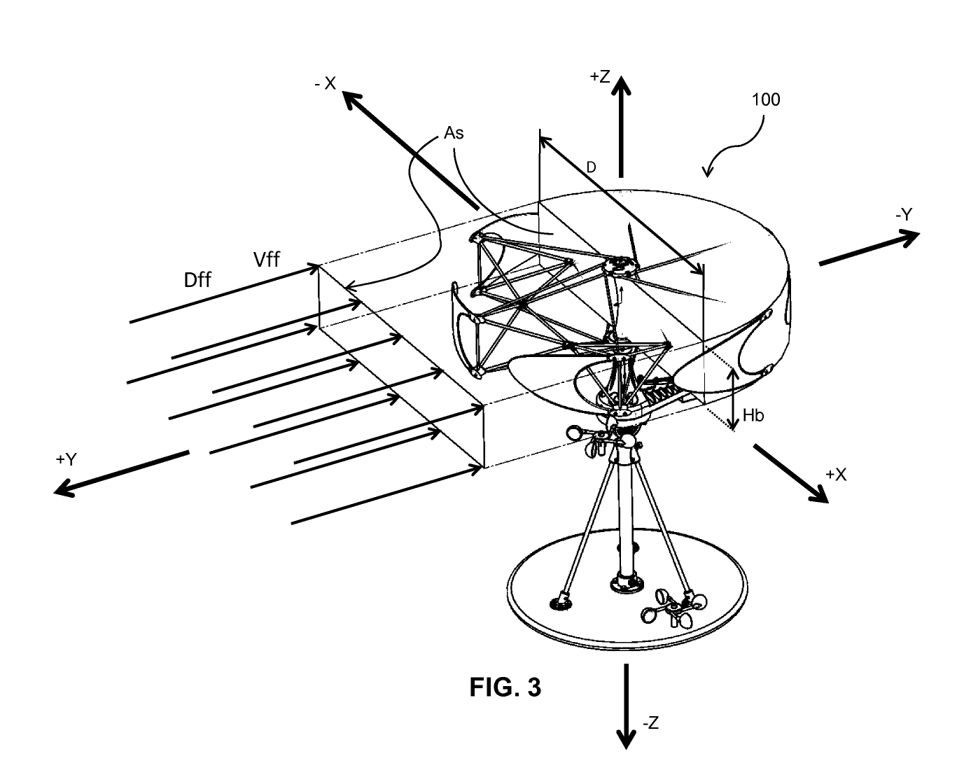

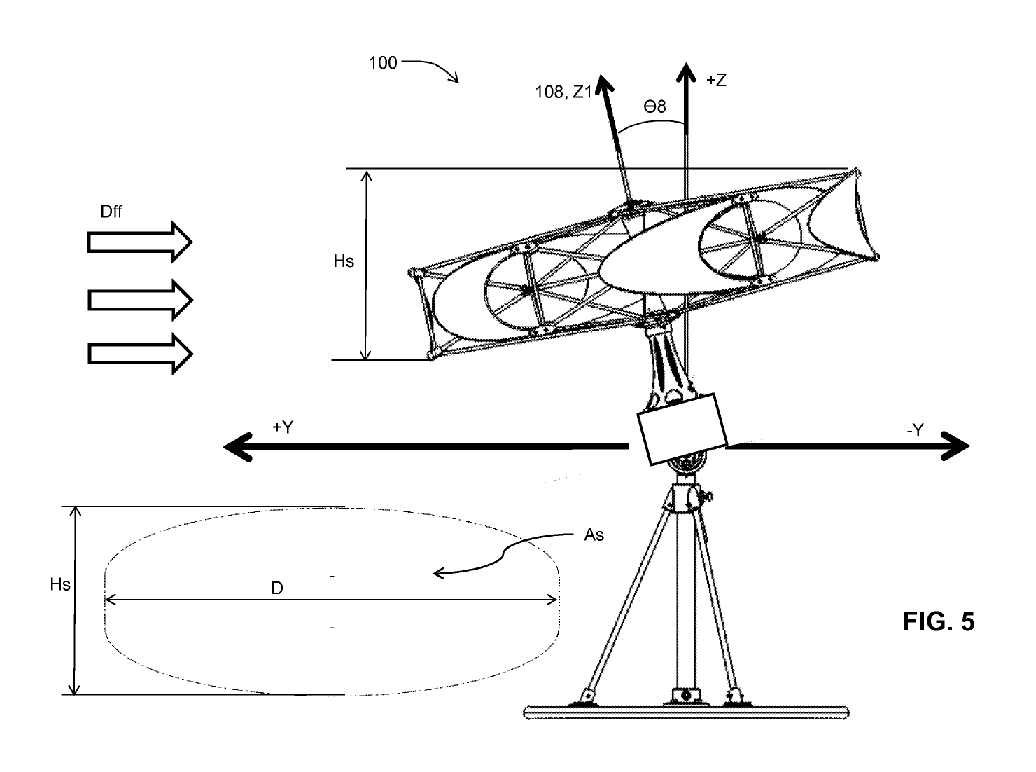

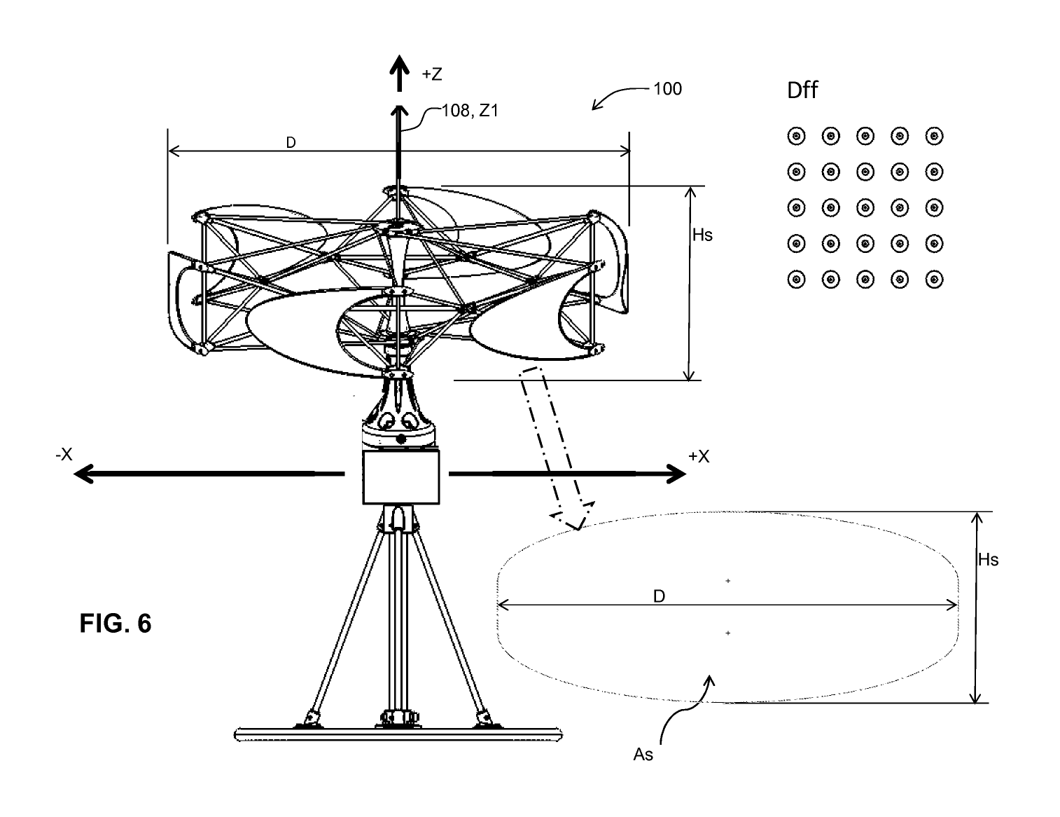

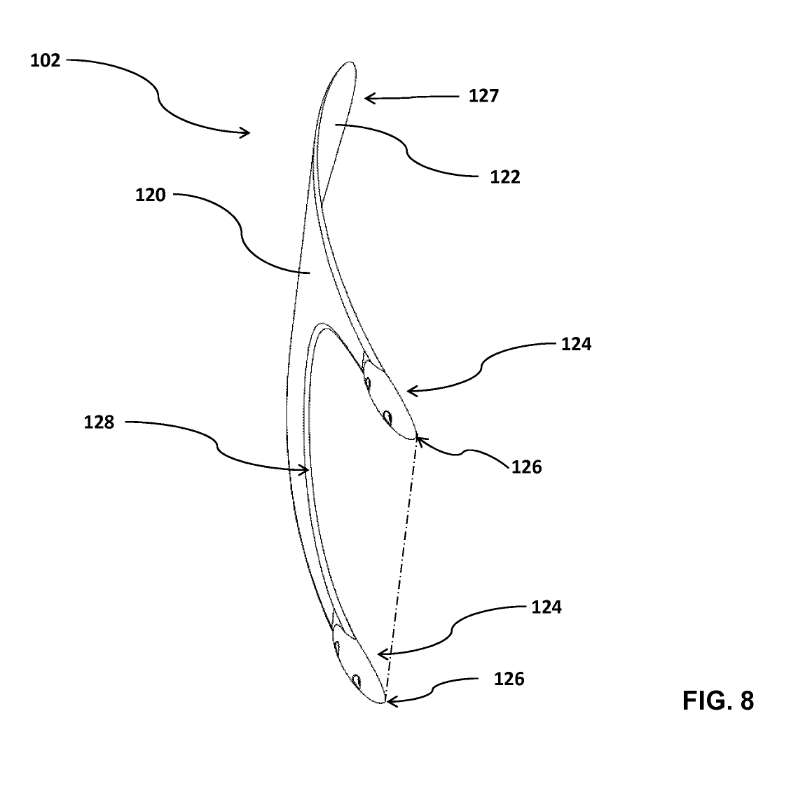

In accordance with the purposes of the present invention, as embodied and broadly described herein, the present invention is a turbine described herein to have spring like characteristics with working blade surfaces somewhat concentric to turbine center and mounted as a cantilever beam to a periphery of a supporting turbine structure. Referring to FIG. 2A-2C, 102 is a resilient (flexible) concentric blade. The leading edge of the blade is attached to the turbine structure 106 by interface component 104 which is referred to as a node. The supporting turbine structure 106 is attached to a central shaft 108. FIG. 8 identifies various key aspects of the blade such as the leading edge of blade 126, trailing edge of blade 127 and blade attachment area 124. A preferred embodiment prototype model is illustrated in FIGS. 3-7, which also shows how frontal sweep area can be varied by tilting the turbine axis off-vertical. The external and internal working surfaces of the blade are identified within FIG. 8 as 120 and 122 respectively and are considered the primary working surfaces of the blade upon which dynamic pressures of the flow field are induced. If the difference in dynamic pressure between 120 and 122 on a single blade is sufficient, deflection of the blade from the relaxed concentric position will occur in a radial direction. If the higher flow field dynamic pressure is on the external blade surface 120, the blade will deflect radially inward toward turbine center. If the higher flow field dynamic pressure is on the internal surface 122, the blade will deflect outward away from turbine center.

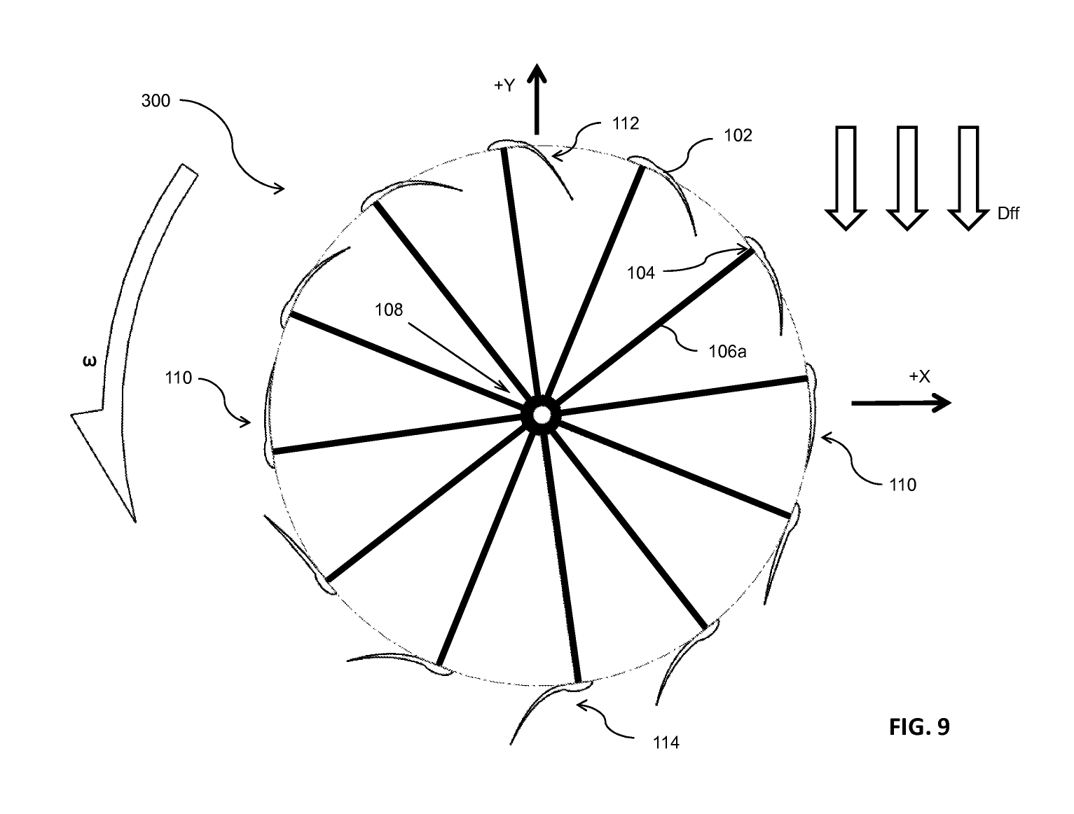

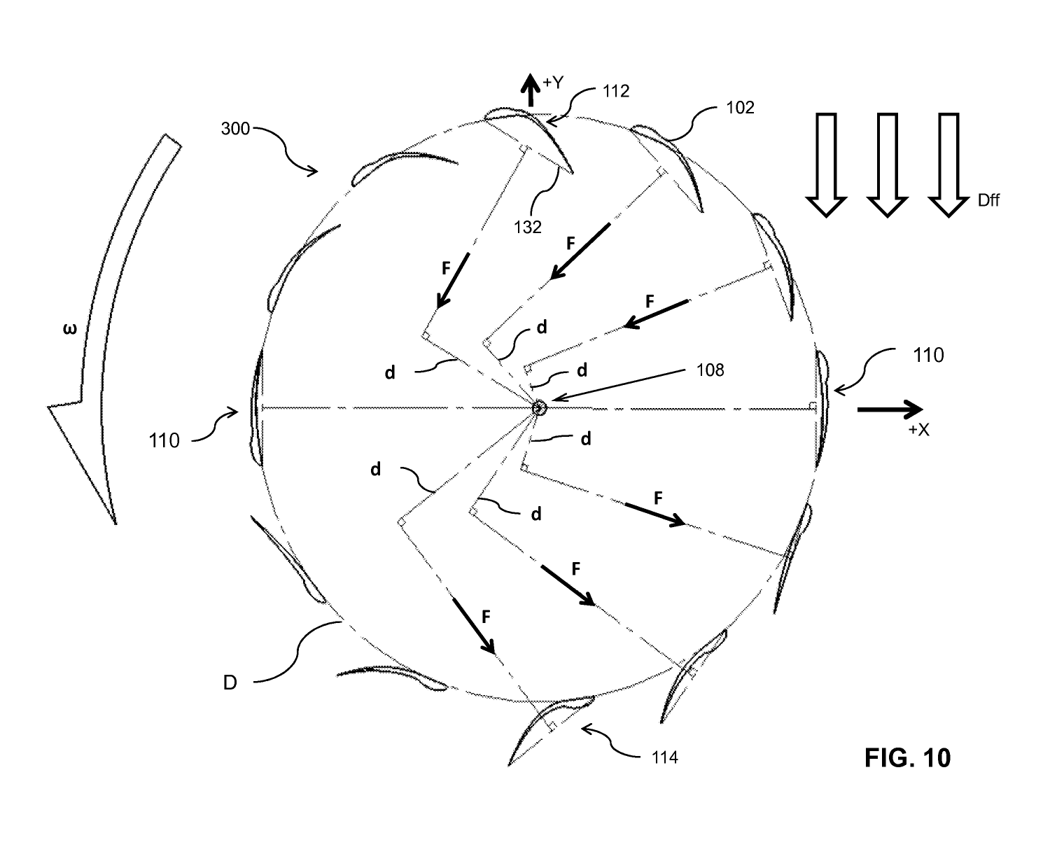

A general description of the deflection cycle for a single blade 102 on the periphery of a vertical axis turbine is illustrated in FIG. 9 with each combination of blade 102 and spoke 106a representing the same blade at different positions of cycle about the turbine periphery. For blade deflections in either inward or outward radial direction, torque will be produced about the turbine center 108 as shown in FIG. 10. As FIG. 10 illustrates, torque produced by both inward and outward deflections result in torque that is consistent with a moment couple rotating the turbine system in the counterclockwise direction CCW. The magnitude of torque generated is the product of force F times distance d as shown in FIG. 10. As the blade 102 is followed through a single cycle about the turbine center, it can be seen that blade deflection is consistent with the blade deflecting inward toward turbine center when located above the X axis, and the blade deflecting outward away from turbine center when the blade position is below the X axis. In other words, blade deflection is consistent with the blade deflecting inward toward turbine center when located within the windward hemicylinder of turbine, and the blade deflecting outward away from turbine center when the blade position is in the downwind hemicylinder of turbine. When the blades are parallel to the direction of flow field Dff, the dynamic pressures on blade surfaces 120 and 122 are somewhat equal resulting in no blade deflection and thus no produced torque as illustrated by blade positions 110 of FIGS. 9 & 10. Within this description, 110 represents a blade passing or at rest at the neutral and concentric position.

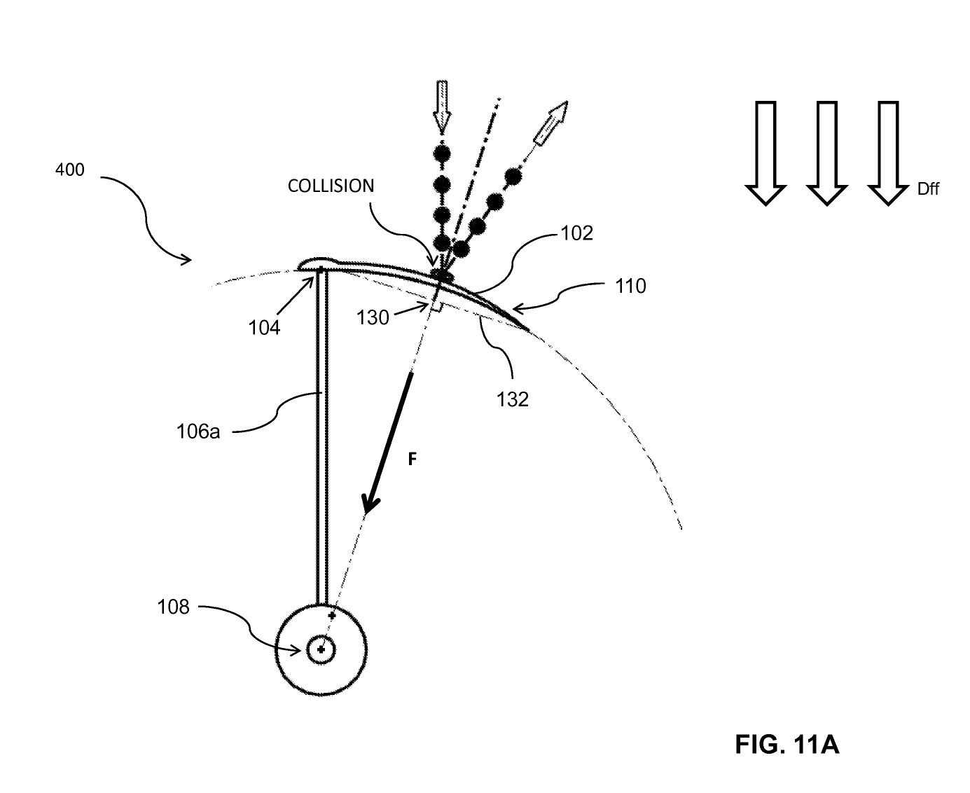

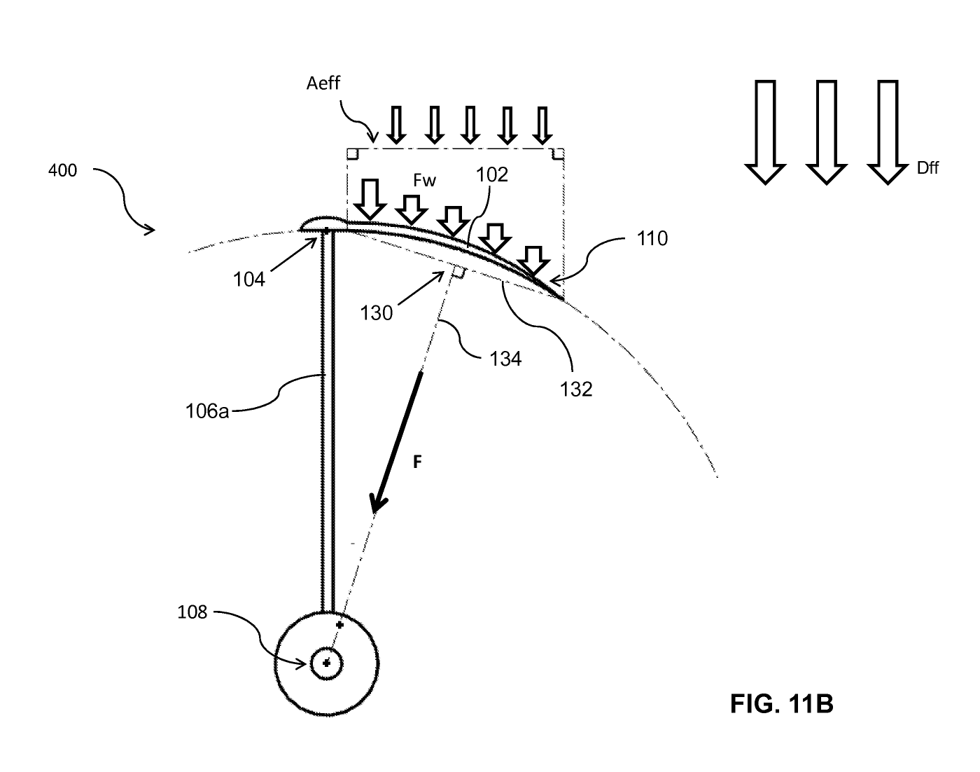

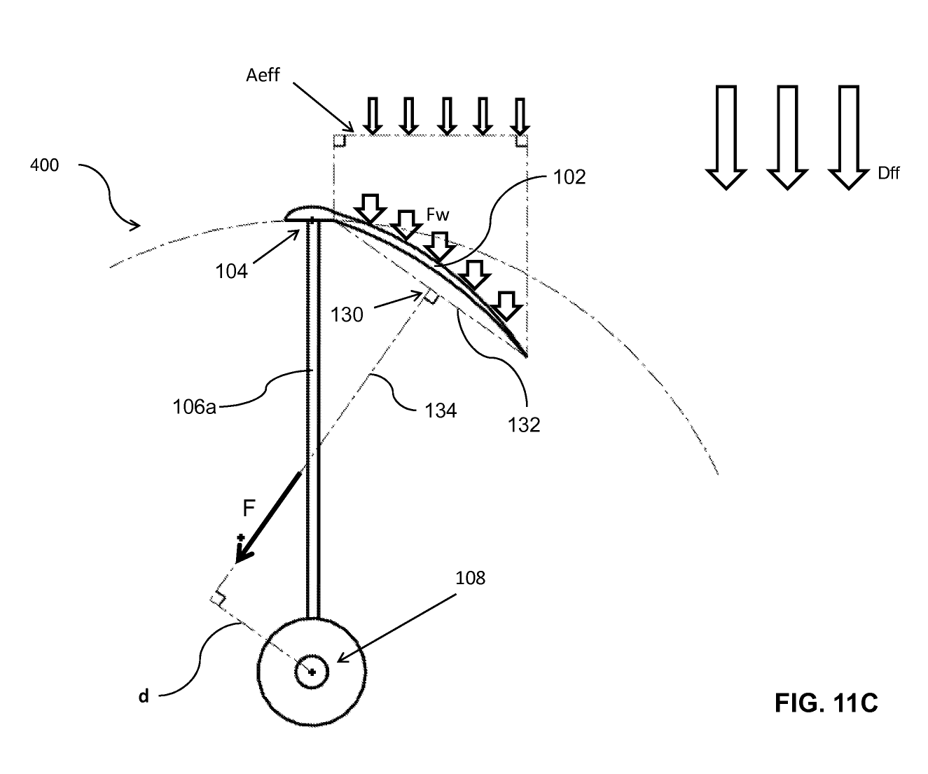

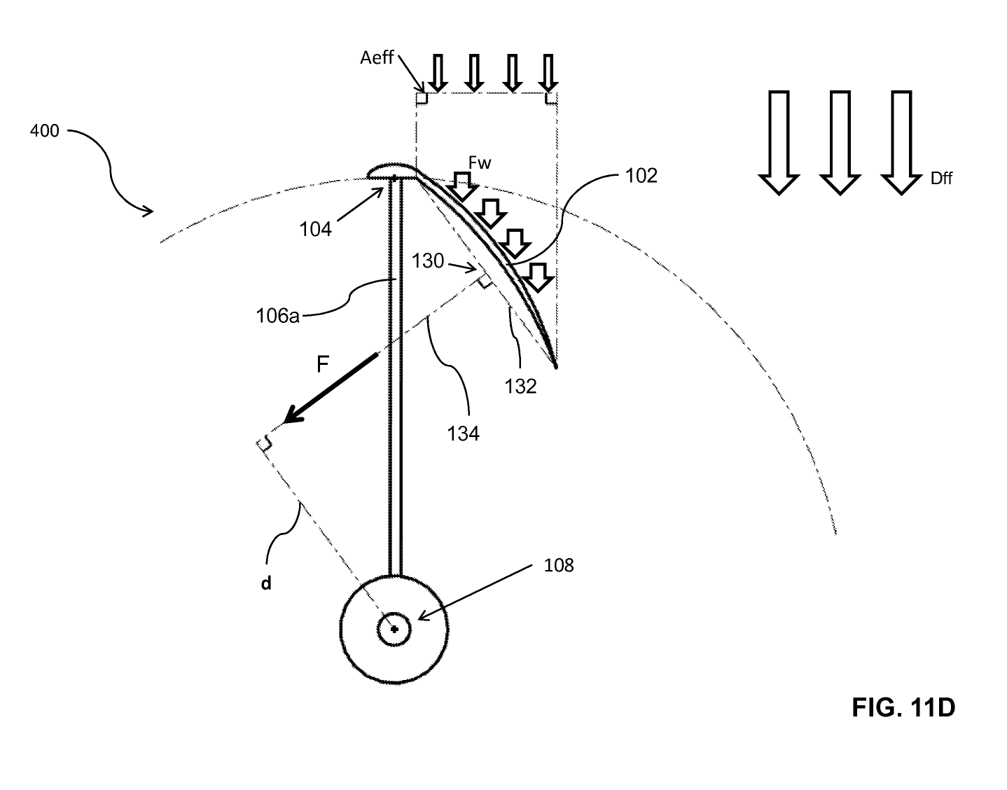

Determining the magnitude of torque for any blade position of cycle can be considered complex when dealing with a blade of curvature and somewhat parabolic deflection along its length. Therefore, for the purpose of simplification, a construction line 132 will be used to represent the equivalent effective area Aeff equal to that of the resilient curved blade as shown in FIGS. 11B-D and 12B-C, the angular deflection of 132 represents the integration of all angularly deflected areas of the blade surface. The direction of the resulting force vector F, will always be perpendicular to 132 with F having magnitude equal to the flow field dynamic pressure of the flow field times Aeff.

The fastened portion of the cantilevered blade 124 always leads the freely suspended blade end while the system is rotating. The resulting turbine central shaft torque and rotational speed equates to the extractable output power.

FIG. 11A illustrates the deflection of a single colliding air molecule transferring momentum to the external blade surface 120 at the neutral position 110. If the blade does not deflect, the reaction force vector F can be seen passing through the center of turbine, unable to produce any effective torque.

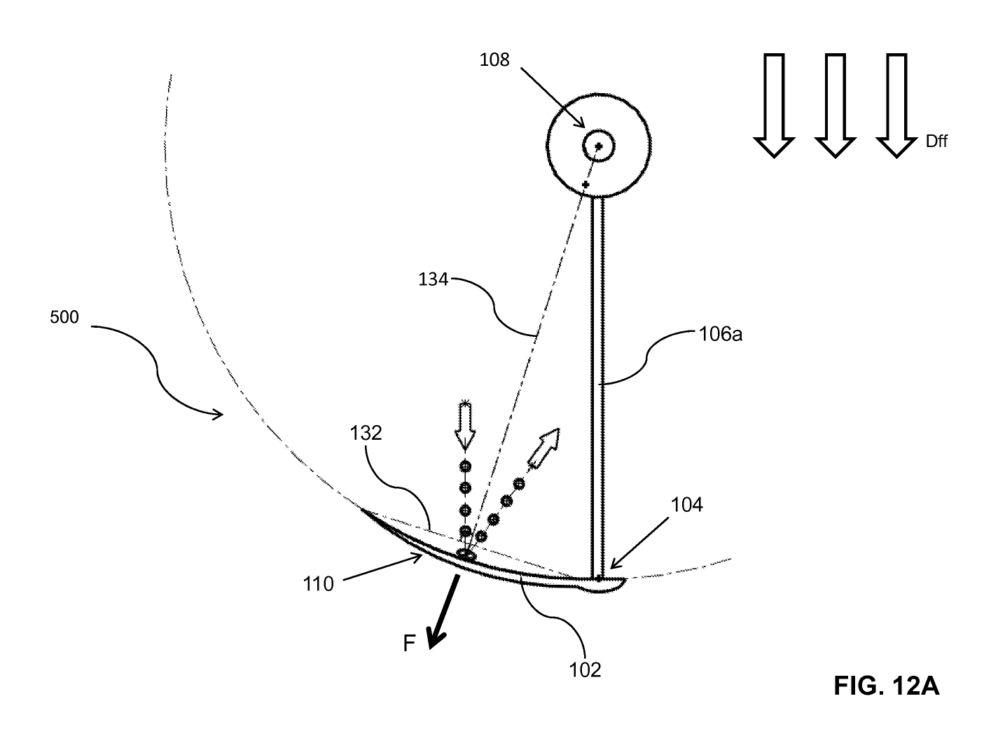

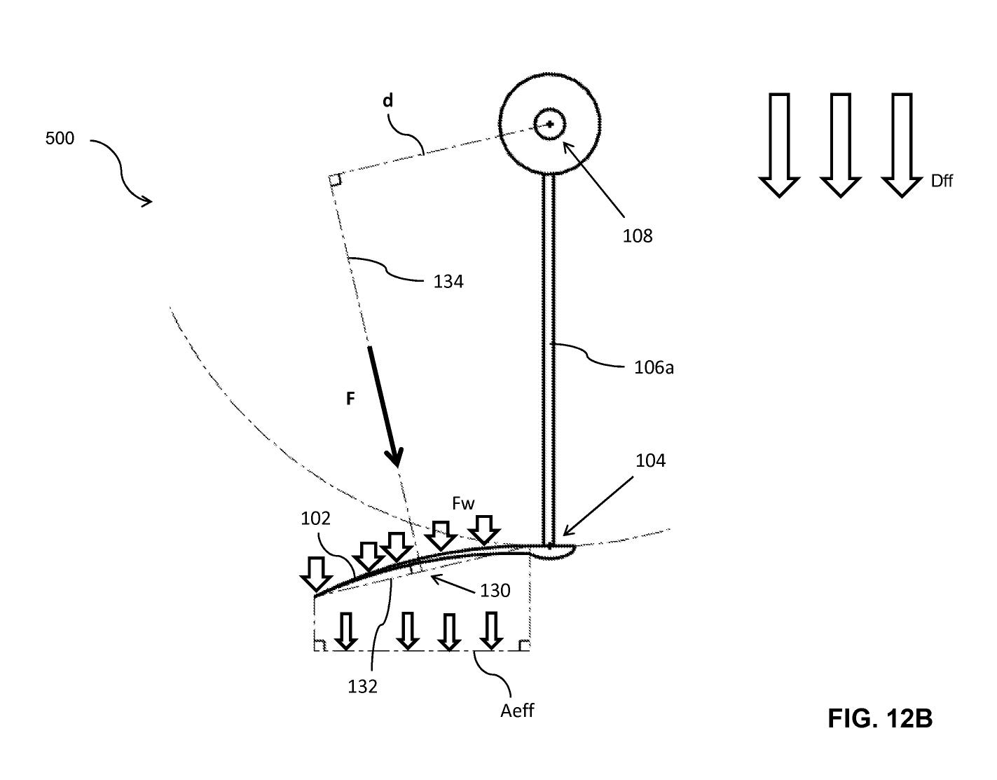

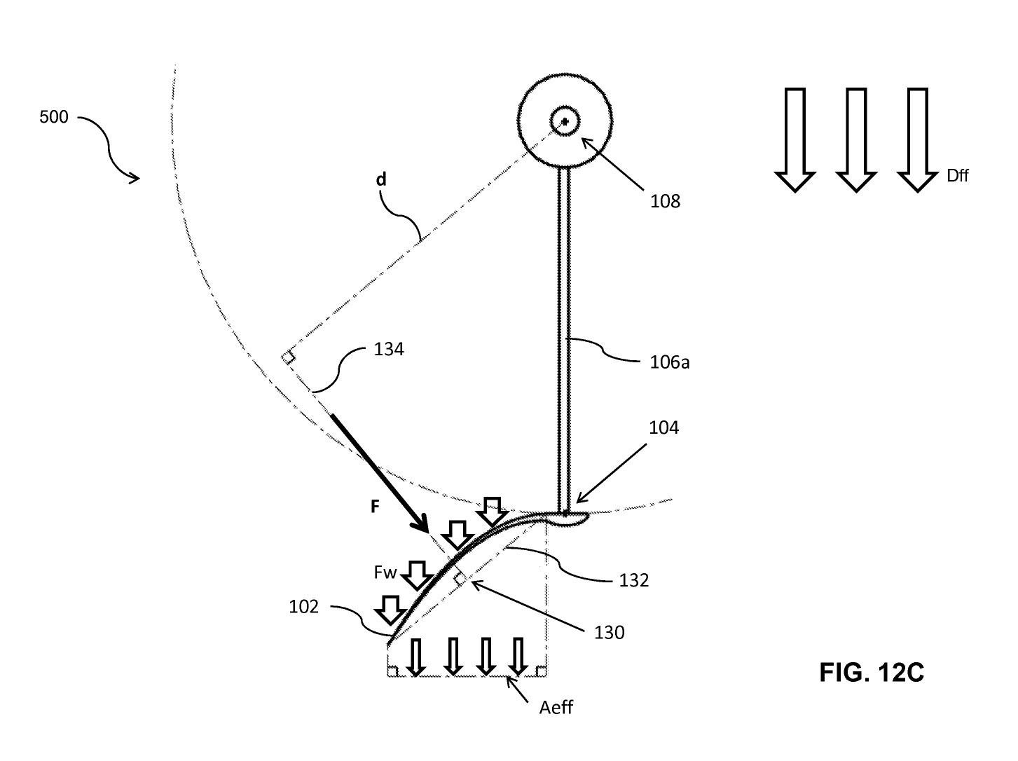

Each air molecule moving with the flow field of an approaching wind possesses a quantum of kinetic energy proportional to its momentum, i.e., mass times velocity. When these air molecules come into contact with a working surface of the turbine blade, an impulse of momentum and kinetic energy transfer to the blade. The turbine of the present invention operates on a principal of resilient blade action and reaction to impacting air molecules. The accumulation of impacting air molecules is commonly referred to in fluid dynamics as “dynamic pressure” acting as seen in FIG. 11B. Increasing working fluid forces imposed upon the blade surface will eventually cause blade deflection as depicted in FIG. 11C. The resulting internal stresses imposed onto the blade are equal to the resulting magnitude of force of which the blade is pushing back against the working fluid. The internal stresses within the deflected blade is in the form of internally stored elastic energy as long as the elastic limits of the blade are not exceeded. As the blade deflects, an instantaneous torque is produced about the turbine system center as a function of force F times distance d. The force vector F acts perpendicular to representative line 132 at effective area centroid 130. For any blade at the neutral position 110, the force vector passes through the turbine center and produces no torque because distance d is equal to zero. When the blade is deflected, internal elastic stresses within the blade are “in balance with” the imposed dynamic pressure acting on either the external or internal blade surface 120 and 122 respectively. Even as the working flow pressure decreases, the internal elastic stresses within the blade continues to push back until allowed to return to the defined net zero internal stress position that is concentric to the turbine center. Production of positive torque in FIG. 10 is in the CCW (counter-clockwise) direction and continuous throughout the blade's cycle of oscillation on both sides of the neutral position 110, with torque constantly changing in magnitude. This action can be visualized in FIG. 10 as the blade is passing from the downwind hemicylinder to the upwind hemicylinder over the +X axis. FIGS. 11B-11D illustrate progressive blade deflection inward toward turbine center, FIGS. 12A through 12C illustrate progressive blade deflection as pressure increases on internal blade surface 122 pushing the blade outward and away from turbine center.

The reasoning for the blade's production of greater torques in the downwind hemicylinder can be seen in FIG. 10, as blade outward deflection results in greater values of d than that of inward deflections. The total kinetic energy of all air molecules impacting upon the blade cause a resultant force vector that passes some distance to one side of the turbine's central axis causing a torque about the turbine center. Providing that the blade length does not exceed 90 degrees of the turbine periphery, the rotational direction of torque produced will remain unidirectional for all blade deflections at any point in the turbine rotational cycle.

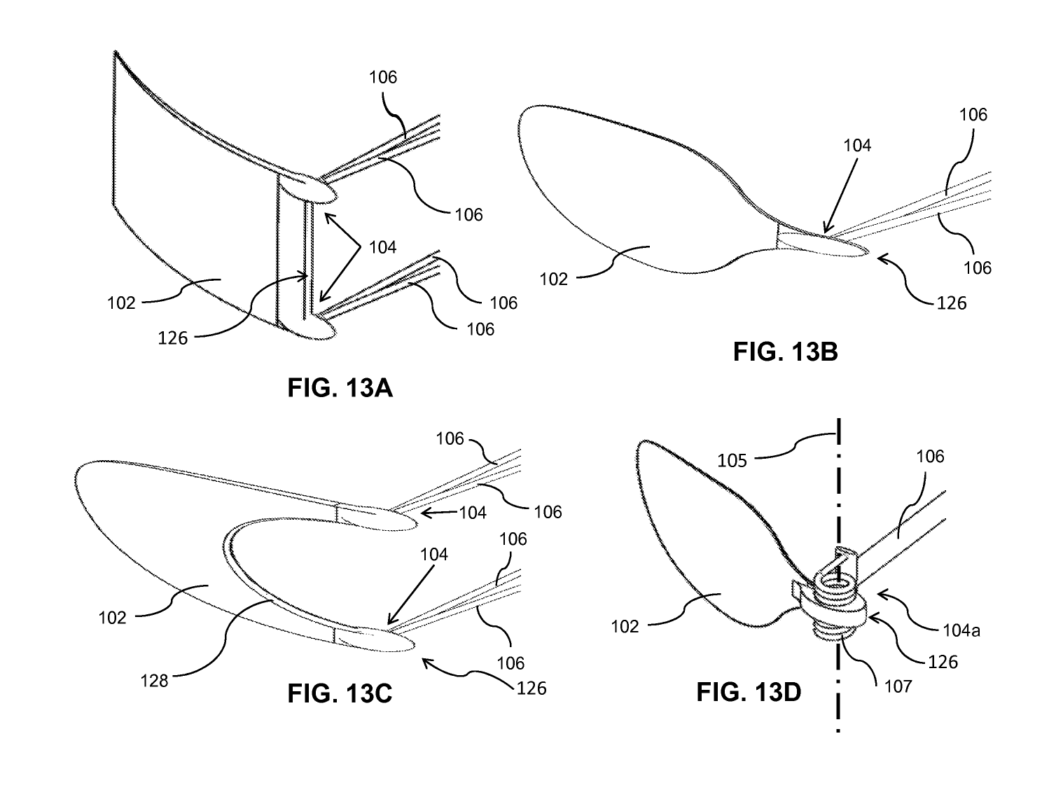

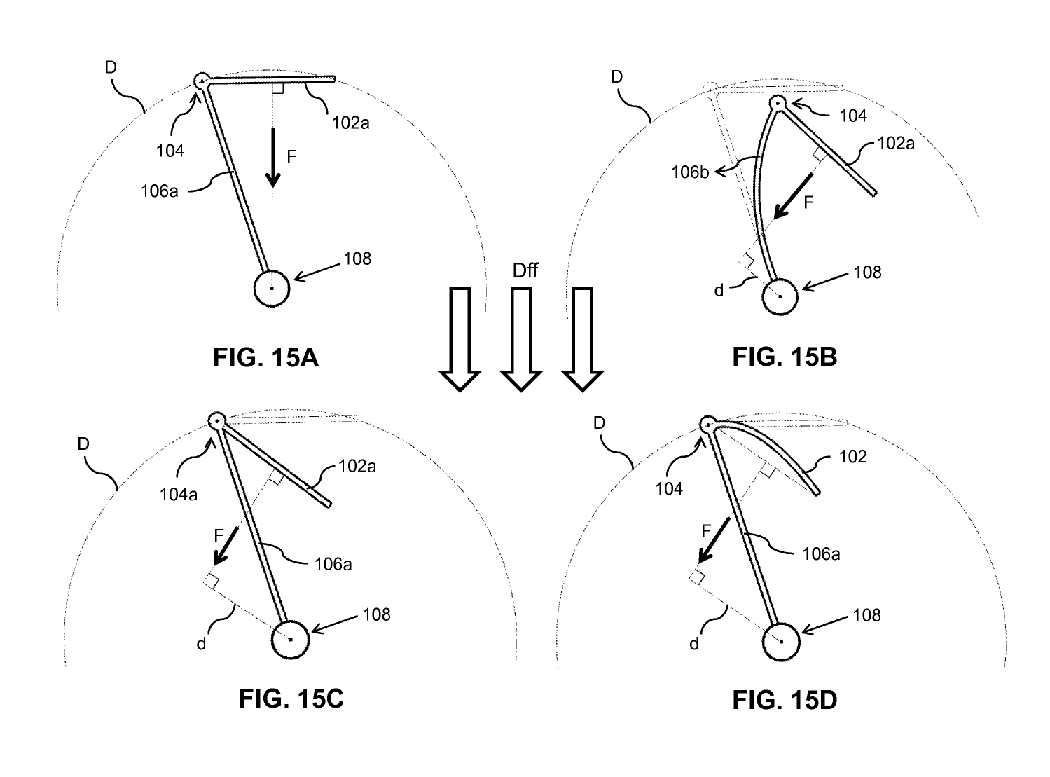

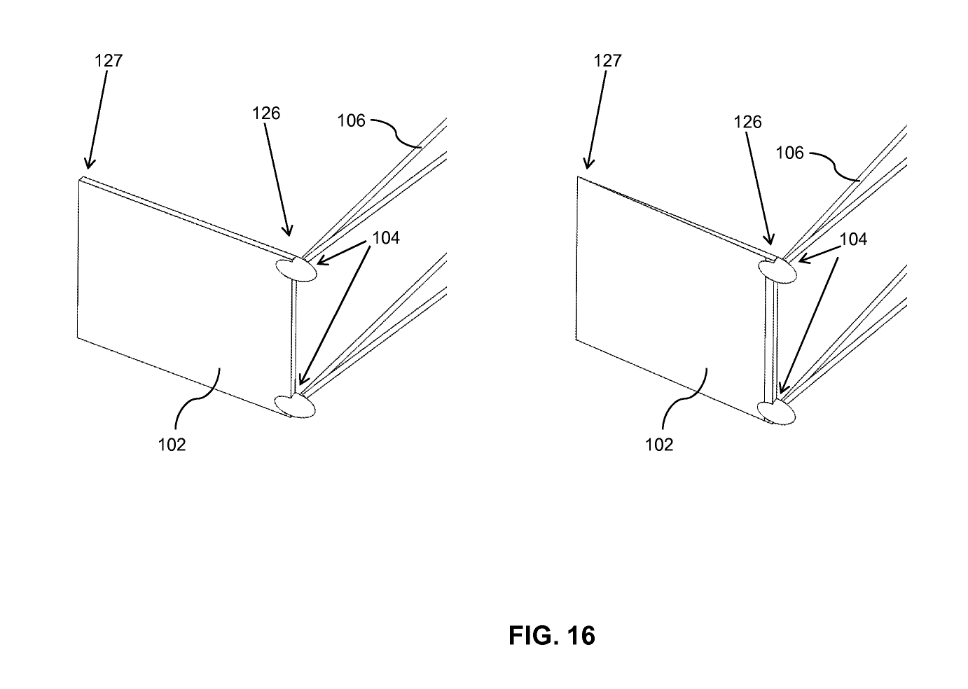

Resilience for storing internal elastic energy is not limited to the blade. FIG. 15B illustrates where spoke 106b has major resilience and is used to store energy. FIGS. 13D, 14 and 15C show node 104a having resilience and used to store energy.

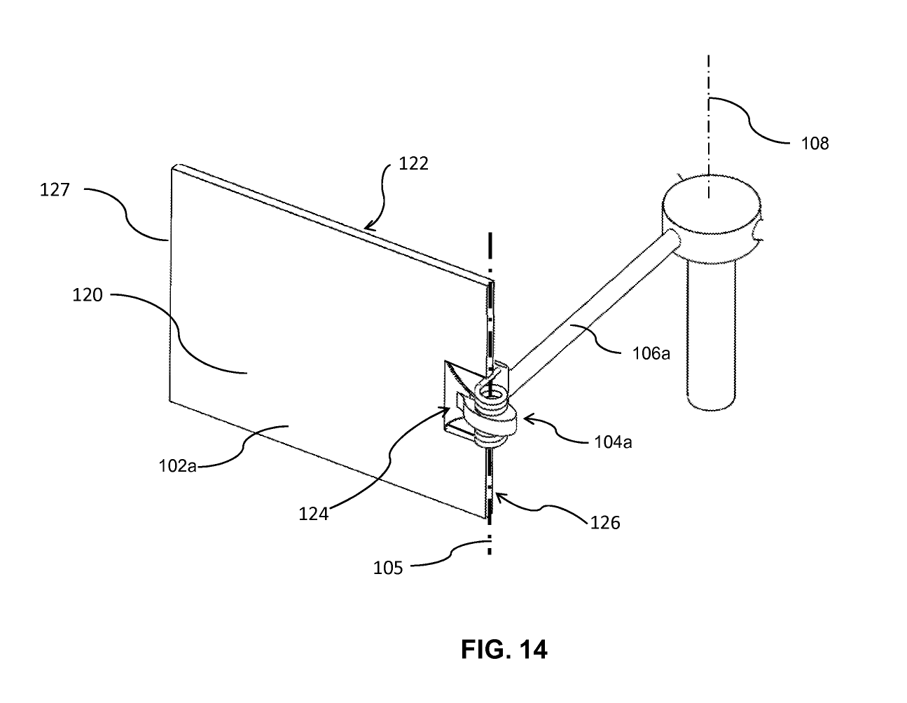

FIGS. 13A-14 illustrate several different embodiments of blades 102 with turbine structure 106 connected via node(s) 104. FIG. 14 shows a blade in the form of a simple flat plate with resilient node 104a. Blade shape, area, and resilience profile may vary, but the inventive blades 102 are all substantially “flat plates” located at a radial distance from the turbine axis 108, extending tangentially from a structure connection node 104 at the leading edge 126 of the blade, and are resiliently flexible both radially inward and radially outward such that the spring bias is toward a neutral position that is tangential. Given these characteristics, the principle of torque production is substantially the same as that of the preferred curved concentric resilient blade. The illustrated variations include a curved or straight flat rectangle (FIGS. 13A and 14); elliptical with a cutout 128 and top+bottom connection nodes 104 (FIG. 13C); paddle shape with one node 104 (FIGS. 13B, 13D); and tapered thickness (FIGS. 13A, 13C). Varying the thickness, cutout area, and shape versus length (distance from node) are all ways to vary the flexibility and resilience for control of the operational characteristics (e.g., amount of bending vs. wind force; e.g., variation of effective area vs. wind force). FIGS. 13D and 14 also show embodiments where the resilience (spring bias) is concentrated in a resilient node 104a. FIG. 14 shows a theoretically “pure” version wherein a bidirectional spring biased node 104a hingedly connects a rigid blade 102a to a rigid spoke 106a to constrain the resilient blade “flexing” to rotation about a hinge axis 105 at the leading edge 126 of the blade 102. Other blade commonalities are labeled in this figure, including blade trailing edge/end 127, blade connection area 124, and outward vs. inward facing sides (120 and 122, respectively).

FIGS. 15A-15D illustrates similar functionality of different turbine configurations with blade resilience being concentrated in different parts of the overall blade-node-spoke assembly (the spoke being representative of the turbine structure 106 connecting the blade 102 to the axis 108). FIG. 15A illustrates a non-functional extreme where the entire blade-node-spoke assembly is rigid, so without deflection from the neutral position, the force resultant F is directed straight toward the axis 108, therefor no torque results. FIG. 15B illustrates a rigid blade 102a and rigid node 104 with a significantly resilient spoke 106b. FIG. 15C illustrates the result of concentrating resilience in the node 104a while the spoke 106a and blade 102a are rigid. FIG. 15D illustrates blade 102 having most of the resilience while node 104 and spoke 106a are substantially rigid. The configurations illustrated in FIGS. 15B-15D all deflect and produce torque as a result of increased dynamic pressure differential between blade inner and outer surface. Multiple components sharing the “internal resilience” allows an engineer to distribute internal energy storage due to resilient deformation to optimize performance vs. durability of flexing components.

The blade on the right side of FIG. 16 shows an example of blade taper which may have only half the mass as the constant thickness blade on the left. Tapering blade thickness along the length from leading edge to trailing edge is a practical way to balance stress distribution. When a blade is deflected, materials near the tail 127 experience lesser internal stresses or store lesser internal elastic energies than materials closer toward the leading edge 126.

Blade stiffness is critical to the speed of blade response. The resulting operating frequency of the turbine will be greater for resilient blades of greater stiffness (i.e., greater spring bias).

For flexible blades, the amount of blade deflection progressively increases starting from near zero deflection at the fixed end of the blade to maximum deflection at the blade tail. As the magnitude of flow field force decreases, elastic energies stored within the blade act as a spring opposed the impacting air molecules or pressure differential until the blade returns to its non-stressed (neutral) position. As the blade rotates about the turbine center submersed within a flow field, cyclic blade deflections toward and away from turbine center continue. The blade deflection is always inward toward turbine center when the blade position lies in the upwind hemicylinder of the turbine and the blade deflection is always outward away from turbine center when the blade position lies within the downwind hemicylinder of the turbine. In other words, the blade deflects to a position inside the turbine periphery when the blade is upwind as in FIGS. 11C-11D, and the blade deflects to a position outside the turbine periphery when the blade is downwind as in FIG. 12B-12C. As viewed from directly above the turbine in (FIG. 9), the freely suspended tail end of the blade traces a repetitive back and forth crossing of the neutral position in a somewhat sinusoidal pattern of motion at a frequency equal to the frequency of turbine system rotation. Force analysis for any cyclic position of the blade on the turbine periphery results in applying torque and angular speed to the turbine center axis with the exception of when the blade passes the neutral position 110 where momentarily the blade is concentric to the turbine center where no contribution to torque or speed is produced.

As blade deflection increases, the center of effective blade area moves and affects the location and direction of the sum equivalent force vector creating the torque. The optimal position for the center of blade area is dependent upon flow conditions and individual turbine design performance criteria and requires involved analysis.

Looking at the blade deflection more closely, the amount of blade deflection can be divided into infinitesimal vertical segments from leading to trailing edge. Each section of which will articulate to a different angular displacement relative to the neutral position. If the blade has equal height and thickness from leading edge to tail, blade deflection will appear somewhat parabolic in shape as viewed from above, with least deflection at the fixed end. By tapering down the blade thickness as on the right side of FIG. 16, a more efficient design may result requiring less mass of materials and allowing the tail to begin flexing and producing torque at lesser dynamic flow field pressures.

For simplifying any mathematical analysis, the net force applied to the entire blade can be represented by a single force vector. This force being equal to the resulting wind pressure times the effective area perpendicular to the flow field direction and passing through the effective area centroid 130. The direction of the resultant force vector will be perpendicular to 132. By mathematical analysis of a single blade throughout the peripheral cycle, the prediction of resulting static forces for a plurality of the blades can be determined by replications of the blade out of phase. The results can then be compared to experimentally recorded data.

Blade reaction to changes in direction of the approaching wind are instantaneous and result in adjustment of the reference X axis which maintains the theoretical intersection of opposing neutral positions between the windward and downwind hemicylinders.

Comparison of Static Torque

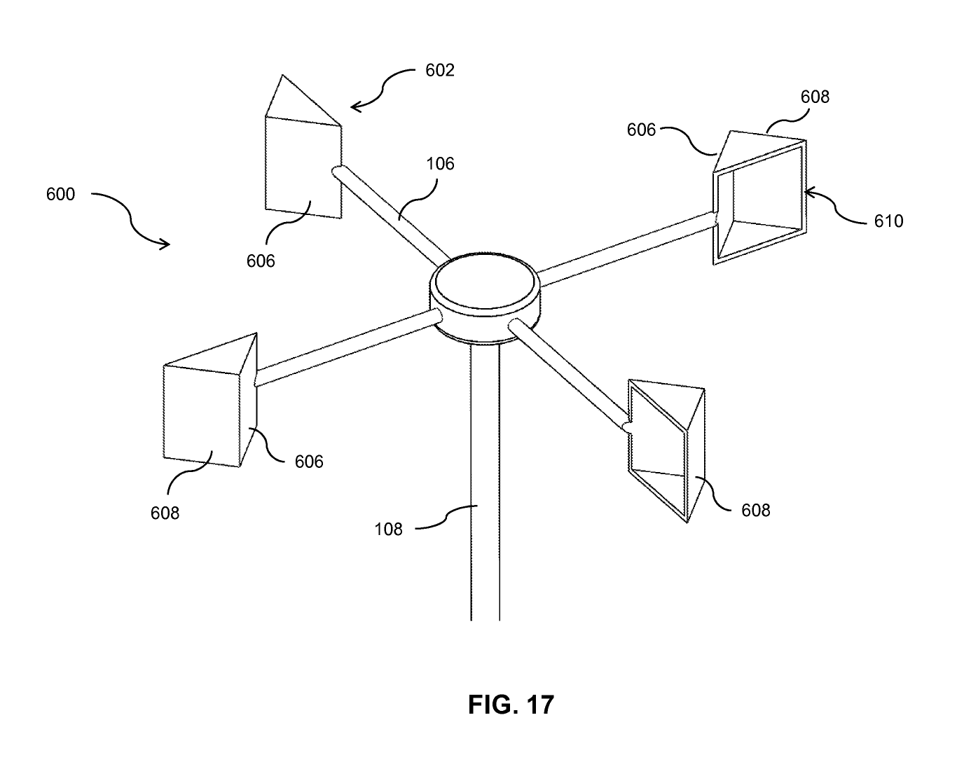

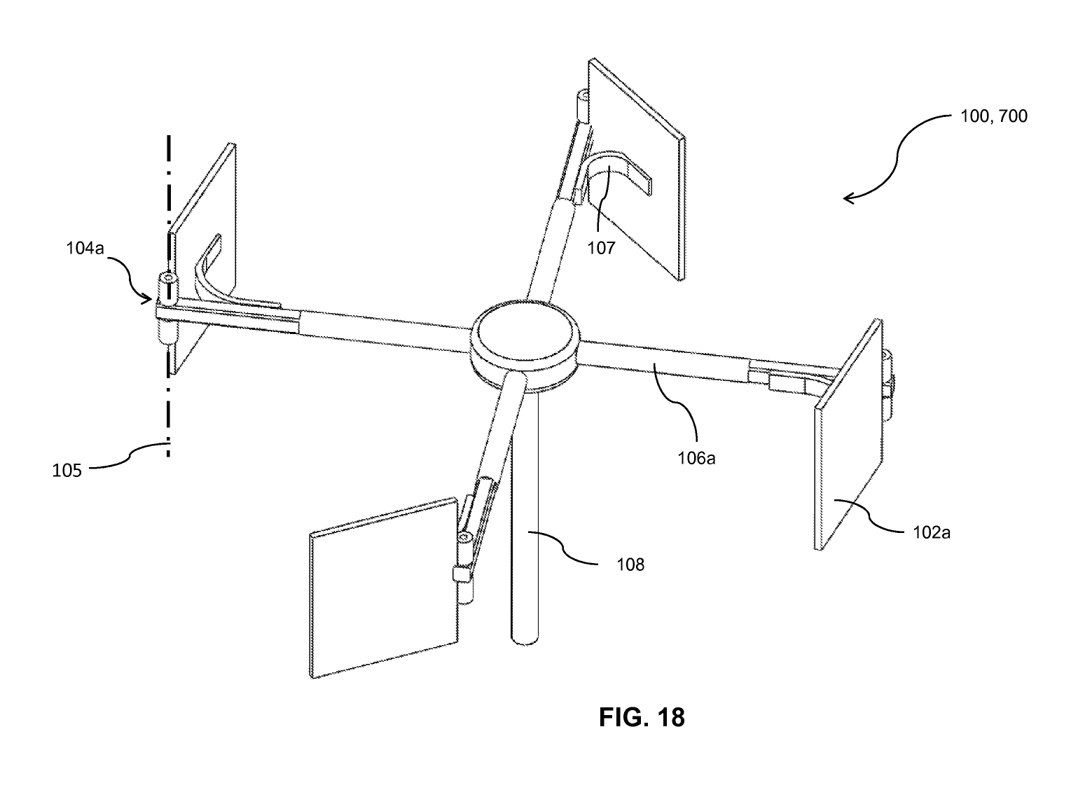

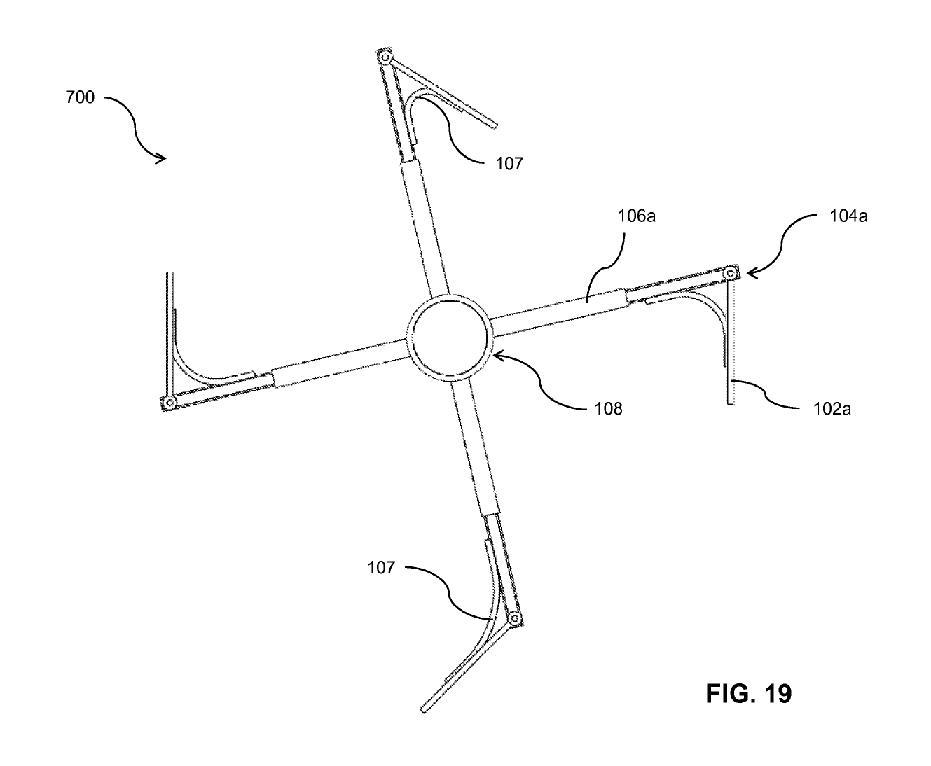

A mathematical comparison of produced static torque was made between a four-cup anemometer type of Savonious turbine shown in FIG. 17, and the new concept turbine with four-blades as shown in FIGS. 18-19. Both turbines possess equal turbine diameter and total frontal sweep area. Each blade of the new concept turbine was sized equal to the frontal area of a single cup of the Savonious turbine. First order calculations were made to define static torque produced by each of the model turbines for comparison under equal working flow conditions. The results indicate that the new concept turbine produces on average static torque 2.4 times greater than that of the equivalent Savonious turbine. Turbine geometry, flow field conditions and applied equations are defined in the tables below.

TABLE I
Savonious (Anemometer) Turbine Data

| | | | | |
|---|---|---|---|---|
| Description | Variable | Value | Units | Equation |

FLOW FIELD CONDITIONS

| | | | | |
|---|---|---|---|---|
| Flow field velocity | Vff | 10.000 | m/s | |
| Air density | ρ | 1.225 | kg/m³ | |
| Wind pressure (force/unit area) | Pw | 61.250 | N/m² | q/S = ρ*V²/2 |

SAVONIOUS (ANEMOMETER) TURBINE GEOMETRY

| | | | | |
|---|---|---|---|---|
| Turbine diameter | D | 1 | m | |
| Turbine radius | R | 0.500 | m | |
| Cup height | Hc | 0.250 | m | |
| Cup face length/width | L_{c} | 0.250 | m | |
| Wedge face length/width | L_{w} | 0.177 | m | |
| Cup face area | Ac | 0.0625 | m² | |
| Wedge face area | Awf | 0.0442 | m² | Hc*Lc/(2*COS(π/4)) |
| Torque arm length for wedge area ″A″ force vector | da | 0.354 | m | R*COS(π/4) |
| Torque arm length for wedge area ″B″ force vector | db | 0.354 | m | R*COS(π/4) |
| Torque arm length for cup area ″C″ force vector | R | 0.500 | m | equal to turbine radius |

DYNAMIC FACTORS

| | | | | |
|---|---|---|---|---|
| Open cup drag coefficient | CDc | 1.350 | — | open cup |
| Wedge drag coefficient | CDw | 1.080 | — | 90 deg closed wedge |

APPLIED VARIABLES AND EQUATIONS AS FUNCTION OF θC

| | | | | |
|---|---|---|---|---|
| Angle +X axis to wedge face ″A″ | θA | — | — | θ + π/4 |
| Angle +X axis to wedge face ″B″ | θB | — | — | θ − π/4 |
| Angle +X axis to open cup face ″C″ | θC | — | — | θ |
| Effective area of wedge face ″A″ normal to flow field direction | Aeff-A | — | — | Awf*ABS(COS(θA)) |
| Effective area of wedge face ″B″ normal to flow field direction | Aeff-B | — | — | Awf*ABS(COS(θB)) |
| Effective area of open cup face ″C″ normal to flow field direction | Aeff-C | — | — | Ac*ABS(COS(θC)) |
| Force vector direction acting on wedge face ″A″ | θfa | — | — | θ − π/4 |
| Force vector direction acting on wedge face ″B″ | θfb | — | — | θ − 3π/4 |
| Force vector direction acting on open cup face C | θfc | — | — | θ + π/2 |
| Force acting on wedge face ″A″ | Fa | — | — | Pw*Aeff*CDw |
| Force acting on wedge face ″B″ | Fb | — | — | Pw*Beff*CDw |
| Force acting on open cup face ″C″ | Fc | — | — | Pw*Ceff*CDc |
| Torque produced by Fa acting on wedge face ″A″ | Ta | — | — | Fa*da |
| Torque produced by Fb acting on wedge face ″B″ | Tb | — | — | Fb*db |
| Torque produced by Fc acting on open cup face ″C″ | Tc | — | — | Fc*dc |

TABLE II
Resilient Blade Turbine Data (Blade Area = same as Cup face area)

| | | | | |
|---|---|---|---|---|
| Description | Variable | Value | Units | Equation |

FLOW FIELD CONDITIONS

| | | | | |
|---|---|---|---|---|
| Flow field velocity | Vff | 10.000 | m/s | |
| Air density | ρ | 1.225 | kg/m³ | |
| Wind pressure (force/unit area) | Pw | 61.250 | N/m² | q/S = ρ*V²/2 |

TURBINE GEOMETRY

| | | | | |
|---|---|---|---|---|
| Turbine diameter | D | 1 | m | |
| Turbine radius | R | 0.500 | m | |
| Blade height | Hb | 0.25 | m | |
| Blade length | L_{B} | 0.25 | m | |
| Blade physical area | Ab | 0.063 | m² | |
| Distance to center of blade | L_{B}/2 | 0.125 | m | |
| Angle between spoke & blade | θ2 | 75.522 | DEG | ACOS(Lb/R) |
| at start position (deg) | | | | |
| Angle between spoke & blade | θ2 | 1.318 | RAD | |
| at start position (rad) | | | | |
| Angle between spoke & +X | θ1 | 14.478 | DEG | 90 − θ2 |
| axis at start position (deg) | | | | |
| Angle between spoke & +X | θ1 | 0.253 | RAD | |
| axis at start position (rad) | | | | |

CYCLE TRIG IDENTITIES

| Quadrant | θ3 | θ4 | θ5 | Aeff | d |
|---|---|---|---|---|---|
| 1 | 0 − π/2 | θ2 − θ3/2 | θ3/2 | ABS(A*COS(π/4)*SIN(θ3)) | R*SIN(π/2 − θ4) − L/2 |
| 2 | π/2 − π | θ2 + (θ3 − π)/2 | (π − θ3)/2 | ″ | ″ |
| 3 | π − 3π/2 | θ2 − π/2 + θ3/2 | 3/2(θ3 − π) | ″ | R*SIN(θ4 − π/2) + Lb/2 |
| 4 | 3π/3 − 2π | θ2 + π − θ3/2 | (2π −θ3)/2 | ″ | ″ |

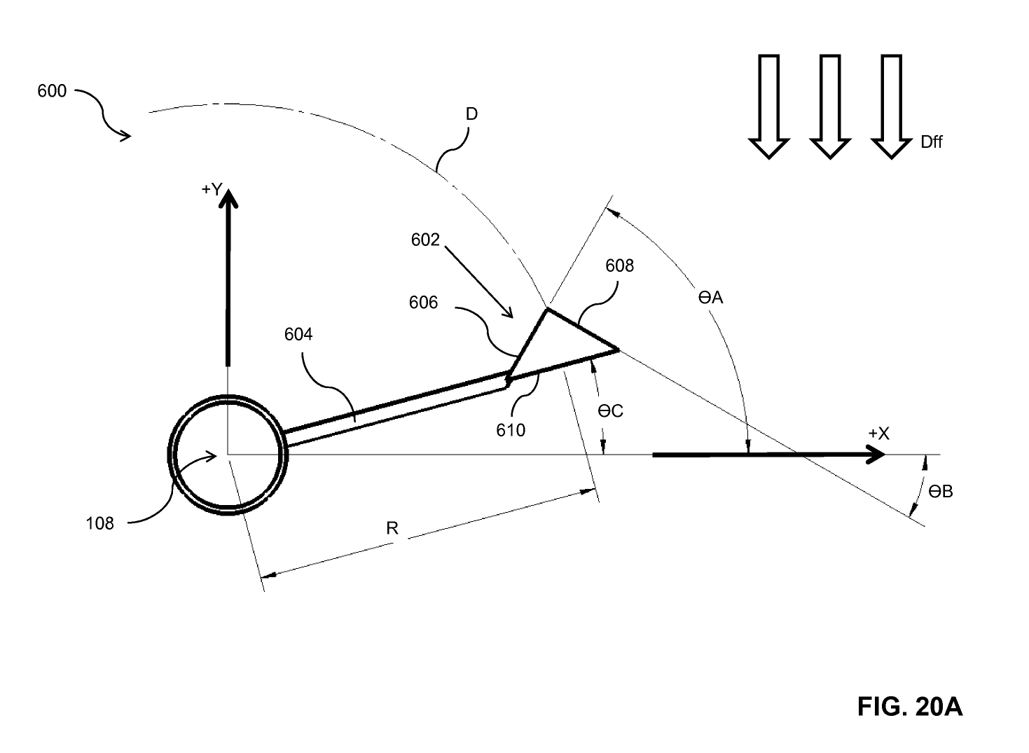

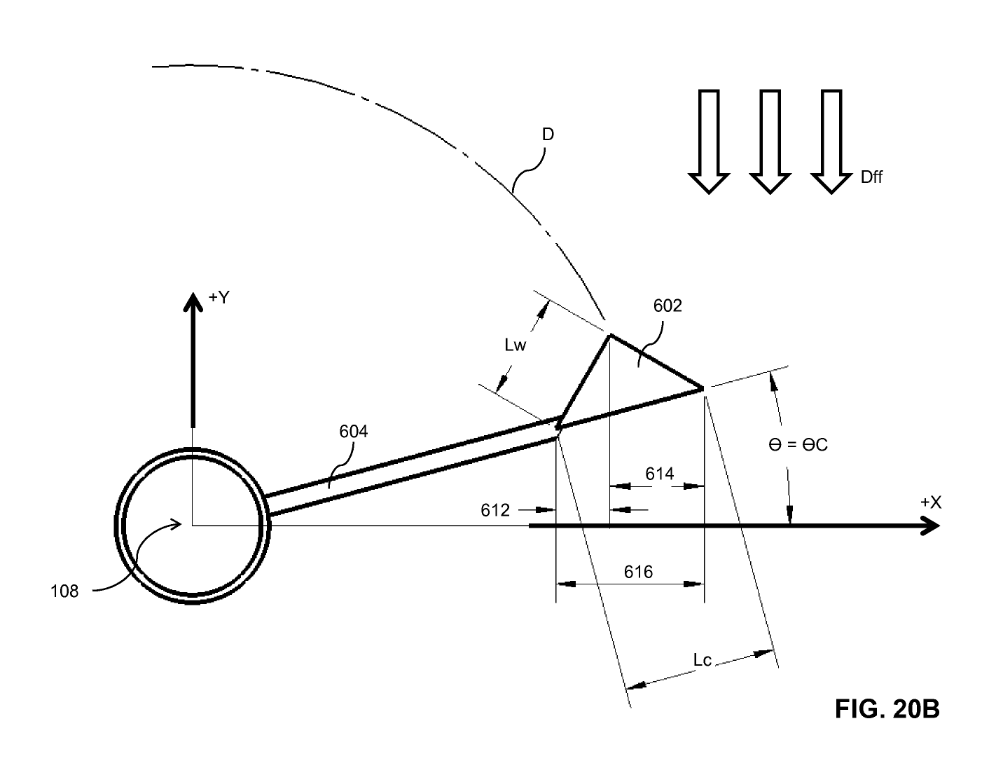

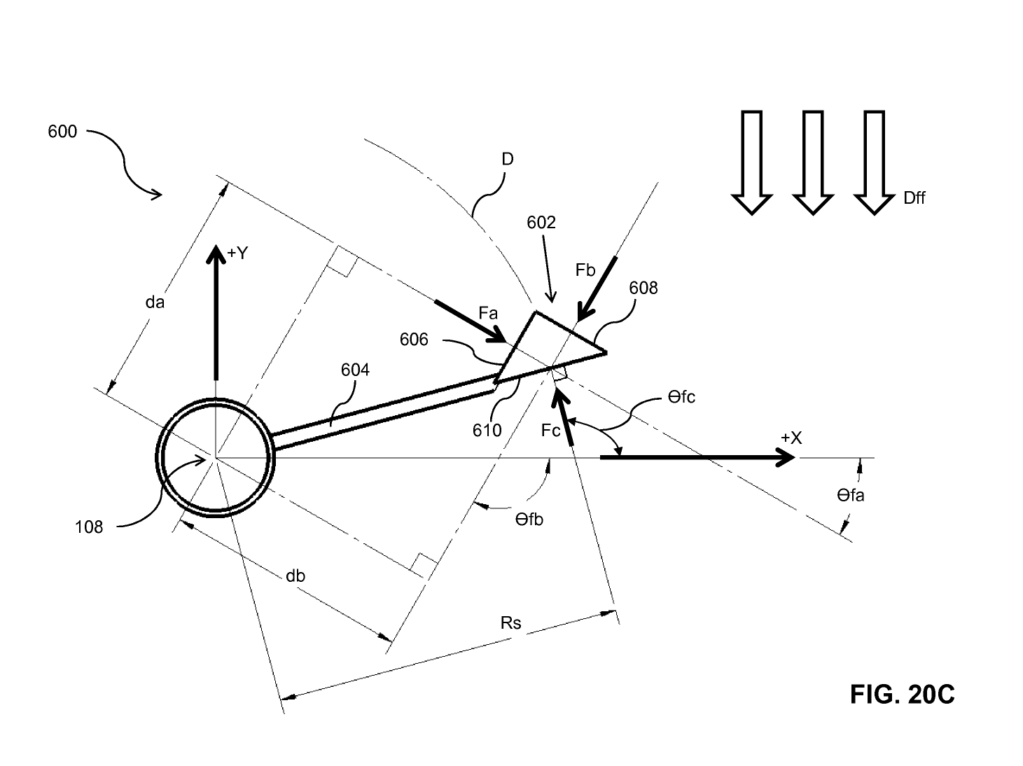

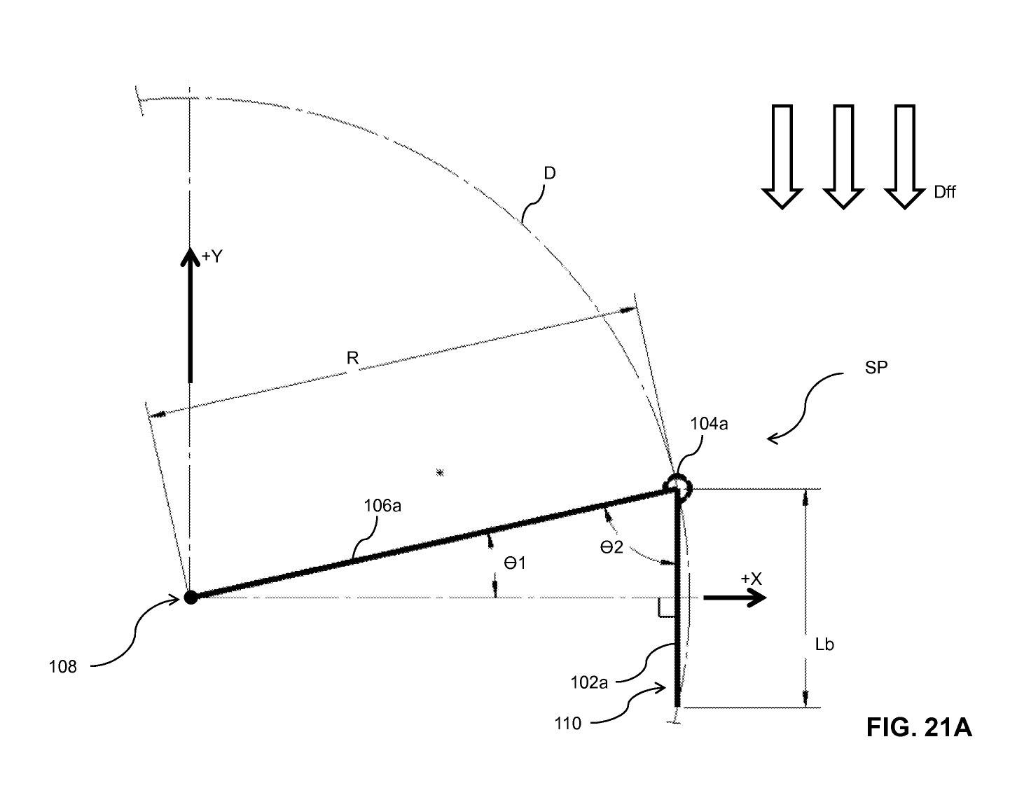

For the Savonious turbine, cup geometry was a hollow straight sided wedge 602 (see FIG. 17) with a 90 degree angle between closed wedge faces 606 and 608 and a radially oriented square cup opening 610 mounted such that the open cup side is open toward and normal to the working fluid flow when it is at the 180 degree position or when θC of FIG. 20A-20C equals 180 degrees. FIG. 20A illustrates a single cup 602 and spoke 604 angularly displaced by amount θC from the starting position where θC equals zero. The center of cup 602 is always located on center with the turbine periphery R and diameter D as the cup rotates in the CCW direction about turbine center axis 108. Wedge face 606 makes angle θA from the +X axis which starts with a value of 45 degrees. θB does the same for wedge face 608. Driving forces impinged from the working fluid upon the open cup was approximated as being entirely due to form drag. The drag coefficient for the open cup is assumed to be 1.35. The drag coefficient for the wedge faces are assumed 1.08. Resistive forces imposed upon the closed wedge faces are considered flat plates, as normal forces are imposed on each wedge face. FIG. 20B illustrates projected effective area widths 612, 614 and 616 for wedge surface A, B and the open cup face respectively. Lw being the width of wedge face A and B and Lc being the width of open cup face C. As the four cups rotate about the turbine axis 108, forces act on both wedge surfaces and the open cup. FIG. 20C illustrates that the resulting forces Fa, Fb and Fc will remain perpendicular to their respective faces. For the open cup face 610, a magnitude of Fc only exists when the cup face is exposed to the approaching flow field Dff. Therefore Fc only exists for θC greater than π/2 radians and less than 3π/2 radians from the starting position. In similar circumstances, Fa on wedge surface A only exists from θC equal to 225 degrees to 45 degrees. For Fb on wedge face B only exists when θC is greater than 315 degrees and less than 135 degrees. For all three cup areas, the respective applied forces upon their surfaces only exist when directly exposed to flow field Dff.

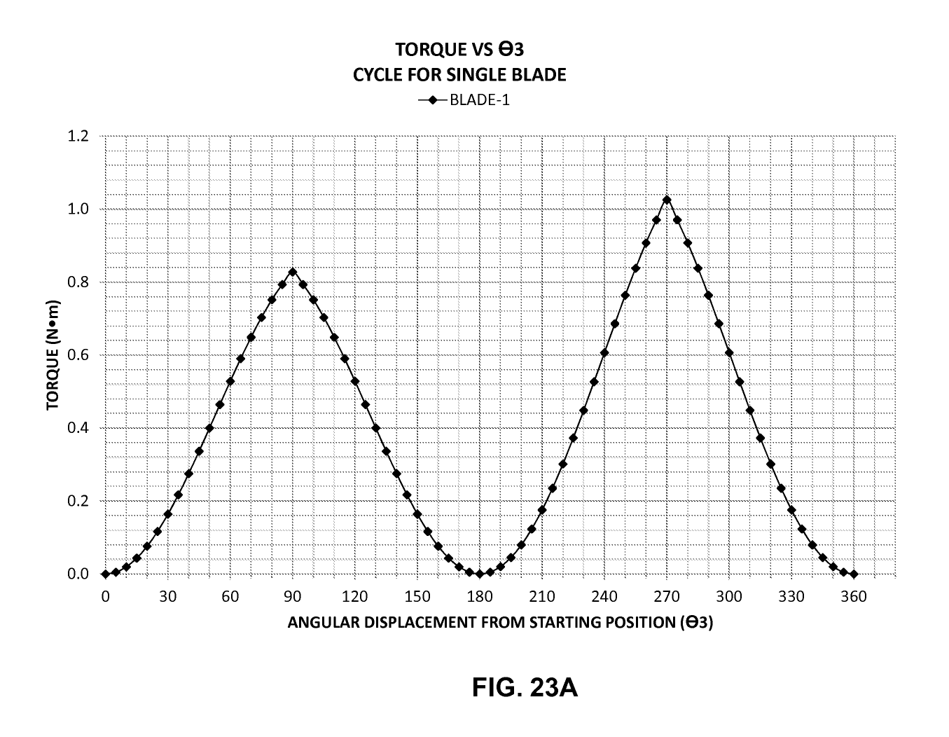

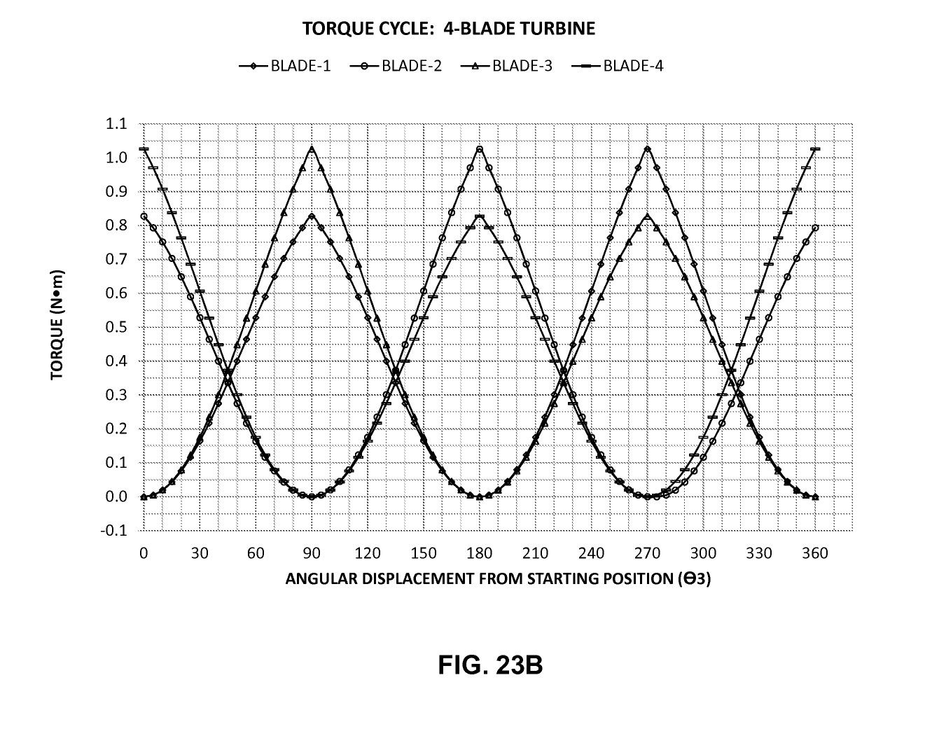

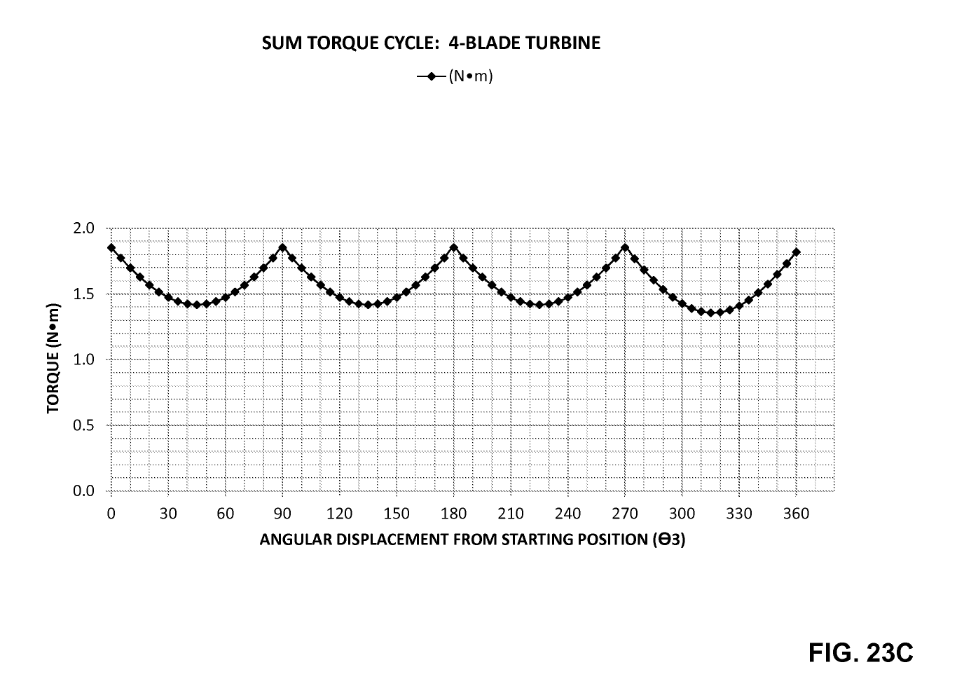

The new inventive turbine example 700 (embodiment of resilient blade turbine 100) used for comparison is shown in FIGS. 18-19 with major spring bias illustrated as 702 (107). Blade 102a and spoke 106a were assumed rigid or in other words, not having flexibility or spring bias. FIG. 21A illustrates turbine for comparison 700 at defined neutral position 110 with the center of blade area in line with the +X axis starting position. Referring to FIG. 21A, if values for turbine diameter D and flat blade length Lb are known, the starting angular displacement of spoke 106a is θ1 from the +X axis and the starting angle between blade 102a and spoke 106a being θ2 can be readily determined. These values refer to the assembly at the starting position only, and do not vary through the analysis of cycle. Referring to FIG. 21B, changes in blade position throughout the cycle were defined by the angular displacement θ3, of 106a from the starting position. Referring to FIG. 21B, for clarity, spring 702 from FIG. 18-19 is replaced by torsion spring bias within node 104a in FIGS. 21A-21D. This torsion is directed tangential to the hinge and deflects by amount θ4. The sum total wind force acting upon the blade was treated as a function of dynamic wind pressure times the blade's effective area Aeff perpendicular to the flow field. The amount of angular displacement from the neutral position and the amount of effective blade area both vary according to the amount of applied wind force and spring stiffness. In practice, the blade displacement self-adjusts until applied wind force and resistive spring force are balanced. For this analysis, changes in blade deflection from the neutral position are assumed to change at a constant rate. Trigonometric calculation sets a 45 degree blade displacement from the working fluid direction at the furthest upstream position yielding the maximum amount of torque for a blade on the upwind half of the turbine (i.e., blade rotation angle between 0 and 180 degrees). We assume that the spring stiffness is such that the optimum 45 degree blade angle results for the blade at the 90 & 270 degree rotation position. The spring bias was considered to operate equally for blade rotation in both inward and outward directions. Optimum torque within the downwind half of the cycle was considered at a blade deflection outward of 45 degrees from working fluid direction at θ3 equaling 270 degrees or 3π/2 radians displacement from the starting position due to the wind impinging on the “back” side (inward face) of the blade 122. It is important to note that the resulting blade angle produced at either upwind or downwind halves of the new turbine both produce torque in a same consistent direction. Calculations assumed that the sum static torque for of a plurality of blades equally out of phase in cycle can be determined by summing the static torques of all four blades which are 90 degrees or π/2 radians successively out of phase in position of the turbine in cycle. The results are graphically displayed in FIGS. 23A-23C. FIG. 23A shows static torque results for a single blade executing a single cycle. FIG. 23B shows graphic results for all four blades equally out of phase. FIG. 23C illustrates the sum torque for all four blades again executing a single cycle. This analysis ignored the complications of inertial forces and complex flow dynamics.

For the new concept turbine, within this static analysis, the angular displacement of blade from the defined neutral position was assumed to vary linearly in oscillating fashion such that blade deflection from neutral position is zero at 0 and 180 degrees of spoke displacement, +45 degrees from neutral position at 90 and 270 degrees of spoke rotation within the cycle of turbine rotation.

For both types of turbine, static torque was calculated for a single cup or blade starting at the positive X axis=0° (degrees), and then recalculated at every 5 degree increment in the counterclockwise (positive angular displacement) direction about the turbine center. The results for each of the remaining three cups or blades was generated by shifting the complete series of torque values for one blade to be 90 degrees out of phase for the next blade. Three graphs were then generated for both turbine types. One graph showing static torque versus angular displacement from starting position for a single blade, another showing the four phase-shifted plots of torque superimposed, and finally a graph of the sum torque for all four cups or blades. The average static torques for the entire cycle was then determined.

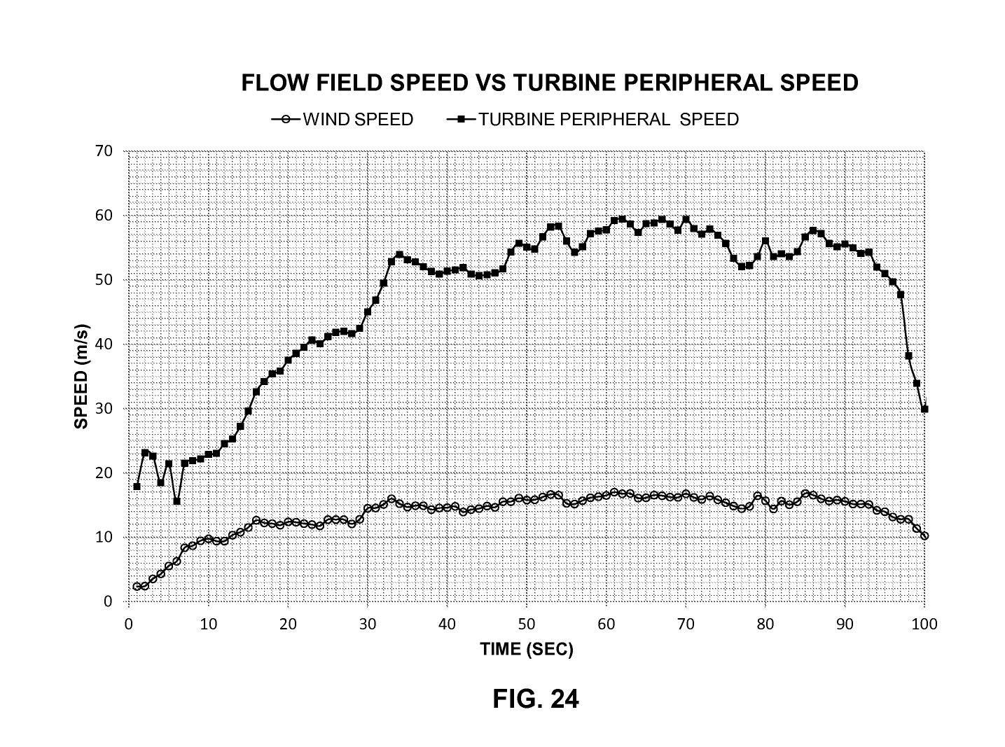

Results indicate that the new inventive turbine produces on average 2.4 times the static torque of the Savonious cup anemometer turbine for equal blade/cup area and equal turbine sweep area. A prototype of the new turbine concept shown in FIGS. 2A-7 was constructed and tested. FIG. 24 show results of approaching wind speed velocity versus the turbine blade speed at the periphery. Results taken from the graph indicate that the blade speed at turbine periphery was on average recorded at 4.2 times greater speed than that of the approaching wind. These results indicate that the new inventive turbine operates on principal of producing forward tangential thrust and does not operate on flow drag.

The cantilevered blade is attached to the turbine structure near the leading edge. A plurality of blades would normally be equally spaced on the turbine periphery resulting in a concert of blades deflecting independently throughout the rotational cycle. The fact that the blades are allowed to react with a flexure reaction independent of other blades on the same turbine is of critical value. While the overall turbine system including turbine structure and plurality of blades react to the applied wind forces as a single component with spring like properties, each blade instantaneously reacts to both flow field forces and accelerations caused by other blades of the same turbine. It can be said that mechanical communication exists between blades as each blade independently reacts in balancing all applied forces. The flow-field forces acting upon the curved blade surfaces will accelerate the turbine tangential speed until balance between rotational drag and the accumulated blade torque is reached, total rotational drag being the sum of resistance drag and generator resistance. The entire plurality of blades of the new turbine concept will have varying amounts of cantilevered deflection while in operation as the plurality of blades are forced to rotate at the same single turbine rotational speed. The action and reaction of each blade imposing relatively instantaneous effect on all other blades through and of the same system.

Hemispherical Torque Imbalance

As illustrated in FIG. 10, the downwind hemicylinder of blade positions has tendency to produce more torque as a result of greater values for d. Observations of actual blade action within the turbine cycle were consistent. This tendency is beneficial to blade life. The ratio of outward deflection to inward deflection increases with speed. During start up, upwind hemicylinder deflections inward can be large and are of significant contribution to decreasing the required turbine start up approaching wind speed. But as turbine rotational speed increases, magnitude of inward blade deflections decrease. Spring cyclic loading with both compressive and tension displacements have tendency to fail earlier than for the same spring deflected in compression only or in tension only.

HAWT Tip Speed Ratio Vs. VAWT Blade Speed Ratio

With horizontal axis turbines, the tip speed ratio is defined as the ratio of blade tip speed to that of the working fluid speed. Tip speed ratios correlate directly to power coefficient. Today's best performing horizontal axis wind turbines operate at tip-speed ratios near 6.0. In comparison, a Savonious type turbine operating off working fluid drag cannot exceed a cup speed ratio of 1.0. Because of differences in blade position and orientation about the turbine, and because the entire blade effective surfaces lie on turbine periphery, the tip speed ratio is not applicable to the new turbine, and a practical substitute can be called the “Blade Speed Ratio”. The blade speed ratio being defined as the turbine tangential speed divided by the approaching flow field velocity. A working prototype of the inventive turbine 100 was designed and tested in order to determine the blade tangential speed ratio. FIG. 24 is an a plot of results comparing blade tangential speed with that of the working fluid. The average ratio based on the results was found to be 4.2.

Turbine Tilt

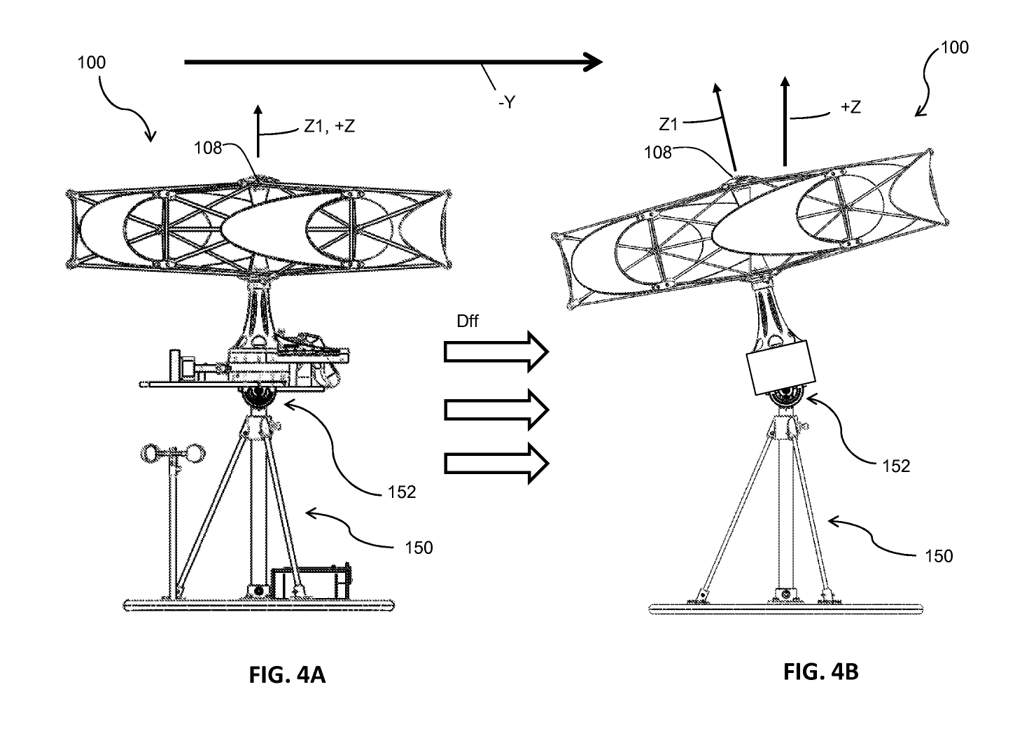

As illustrated in FIGS. 4-7, the sweep area of a vertical axis turbine can be increased by pivoting the main turbine axis 108 by θ8 from the Z axis until 90 degrees. Increasing the sweep area results in an increase to the amount of potential energy available. As θ8 is increased, the effective blade area perpendicular to the wind decreases. The optimal orientation for maximizing the power coefficient involves many factors of the design. In general, as the turbine increases its speed in a single direction, a whirlpool or tornado effect is introduced affecting the flow of the approaching wind inside the diameter of the turbine. As in any constant direction circular flow induced by an impeller, a pressure drop at center results which can extend to affect the fluid flow prior to reaching the turbine itself. The result potentially being a circulation laminar type flow through the turbine system enhancing performance and power coefficient as compared with the same system in erratic turbulent flow.

Blade Design

The resilient blade 102 of the present invention has resemblance to a single leaf of a common automobile leaf spring in that both are relatively flat and curved with design intent to reflect loads in the radial direction with longevity in cyclic loading being of major design concern. The blade of the present invention differs by having the tail end free and representative of the free end of a cantilevered beam with progressive deflection toward the tail. As the turbine diameter becomes large enough, the blade of the present invention can be generally flat with minimal frontal drag and can be constructed with lesser mass of materials per unit of power output as compared with conventional airfoil blades based on airfoil lift which are considerably more complex to construct with complex airfoil geometry. The present inventive blades 102 may have shape resembling an airfoil by having a taper in thickness from leading edge to trailing edge and a rounded forward edge however the principal of turbine thrust development is considered dynamically different. Where the conventional airfoil varying thickness and profile are determined based on desired airfoil lift, the varying thickness and profile for the blade of the present invention is based on the desired proper internal stress distribution and desired spring characteristics or elastic energy storage capacity. With optimization, the present invention has potential to be more efficient than conventional designs as based on the power output per unit area of frontal sweep.

The cantilevered blade of the present invention has advantage in being tailorable in design such that the blade will naturally deflect to a lesser effective frontal area as wind forces become excessive. As blade deflection progresses, resulting torque climbs simultaneously as the effective blade surface area perpendicular to the approaching wind decreases. This can be seen for blade positions at the upwind hemicylinder in FIGS. 11C and 11D where the effective blade area Aeff decreases in width with greater wind load. The same occurs for blade positions in the downwind hemicylinder in FIGS. 12B and C. The result is a point of blade deflection where torque reaches a maximum and any further deflection causes the effective blade area to decrease. This is beneficial in producing a natural “blade feathering” affect. The blade design can thus be tailored to a desired torque limit at which no greater torque can be produced. If flow field energies are excessive, blade deflection also becomes excessive and results in a decrease in effective blade area, allowing excessive energy to pass instead of causing physical damage to the blade or turbine.

The blade geometry is best starting with greater thickness at the leading edge where stresses are greatest while tapering to a relatively lesser thickness at the trailing edge or tail of the blade where induced stresses are minimal. The objective of taper is to minimize and balance externally applied energies along the blade length so that the induced stresses are distributed as even as possible to promote longevity. Excessive blade mass correlates to excessive blade momentum during oscillation and can be detrimental by reducing oscillation frequency and unnecessarily adding to the internal stresses generated. Blade area near the tail end supports significantly less load thus requiring less blade mass. The blade material properties of resilience, strength and elasticity are critical to blade performance. Perfectly rigid blades and turbine system would not suffice for the concept to work. If the materials used to construct the blade and turbine system were perfectly rigid, impacting air molecules would not impose deflection from the concentric neutral position and no torque would be produced. At the other extreme, perfectly elastic blades would not suffice. Perfectly elastic blades would have no resistance to deflection at all, and again no torque would be produced. The blade's resistance to deflection is critical to function of the blade invention and thus engineered to deflect by such an amount as to optimize performance and longevity. The engineering details of which can be exhaustive in the documentation necessary to properly define.

Referring to exemplary illustrations in FIGS. 13A-13D, the external profile or shape of the blade can be one of many numerous applicable geometries. A rectangular shaped blade (FIG. 13A) may appear to yield best performance by maximizing coverage of the control volume sweep area. However, an elliptical shape blade as in FIGS. 13B-13D may yield comparable performance while being found as more aesthetically pleasing. Regardless of blade shape, some fundamental principles regarding the distribution of effective blade area along the blade length do not change. The blade effective surface area nearer the forward fixed end of the blade has greater rigidity and strength with significantly less deflection and production of torque. Therefore lesser working surface areas is desired approaching the fixed end of the blade. As an example, the blade of FIG. 13C would be considered of better design than the blade of FIG. 13A. This is because blade material that would occupy area 128 near the rigid leading edge may have minimum deflection such that a greater magnitude of negative drag is produced during the upstream travel than that of positive torque produced by the same area. FIG. 13B demonstrates a blade with single fixed end connection to the turbine structure with less effective area also being removed above and below the node 104. The best design of the inventive blade will have a progressively increasing spring like energy storage capacity and strength starting from zero at the blade tail and increasing as extending to the fixed blade end to balance the increase in cantilevered beam type induced stresses. The best design may also have a progressively decreasing amount of effective surface area from tail to fixed blade end. Removal of blade area near the fixed end is ideally the portion of blade area that causes greater rotational drag than that same area's possible contribution to effective forward torque. Development and testing may lead to better performing shapes.

It should be noted that as the size of the turbine diameter increases, the cyclic loading frequency will decrease resulting in greater blade longevity for the same resilience. The internally stored energy inside a blade can be perceived as an array of material atoms separated by springs that lie between holding the atoms together. Point being that the inventive blade works the same whether resilience lies within the blade material itself, or if the blade is physically constructed of segments separated by springs. FIGS. 25A-25E illustrate another configuration of the inventive blade. In this configuration, the blade is divided into two vertical blade segments 102′ and 102″ which are both considered non-flexible. Both 102′ and 102″ are co-hinged, and free to pivot about vertical axis 808. FIG. 25B is an exploded diagram of the example spring mechanism. Leading blade segment 102′ is free to pivot about axis 804 by pivot pin 820 which is fixed to node 104. Pivot pin 822 is fixed to node 104 and secures pivot stem 812 in position and allows pivot stem 812 to rotate freely about axis 806. It should be noted that the distance between parallel axis 804 and 806 is fixed as both axis remain perpendicular and intersecting axis 802. A mechanical spring 810 is encased inside of trailing blade 102″. The front end of spring 812 rests against bushing 824 while the rear end of spring 810 rests against retaining bushing 814. Set pin 816 holds 814 fixed to pivot stem 812 at a position where spring 810 is in contact with bushing 824 and 814 in a relaxed state as long as trailing blade segment 102″ is in line with leading blade segment 102′. Deflection of trailing blade segment 102″ either inward toward turbine center or outward away from turbine center results in compression of spring 810 which reacts to move the orientation of both blade segments back to an inline neutral position. Axis 802 is tangent to the turbine periphery and always perpendicular to the turbine center. Since the distance between 814 and 824 is fixed to equal the length of the relaxed spring when blade segments are in line with the neutral position and axis 802, the spring 810 will only experience cycles of compression and never experience cycles of tension. Both blade segments 102′ and 102″ will pivot in the same rotational direction dependent upon which side of the neutral axis 802 they lie.

Blade Material

Some applicable materials (but not limited to) for blade material include spring steels, silicon carbide, carbon Fiber-Epoxy composites, elastomers, rubber and polyurethanes which demonstrate high resistance to cyclic flex, fatigue and creep. Some urethane resins are demonstrating excellent results as well finding use as automotive leaf springs. By designing the blade such that stress limits remain below the material elastic limit, the cycles to blade failure are deemed economically practical. The critical material property being resilience and resistance to fatigue and creep.

Techniques applied to design and construction of parts made of composite materials can result in the blade having sufficient longevity and cost effectiveness.

For example:

Orient composite filaments into a wave pattern traversing from leading to trailing edge for greater flexibility.

Minimize composite filament end count.

Tailor composite fiber path continuously around fixed nodes at the leading edge.

Tailoring blade thickness from leading edge to tail according to variations in imposed stress.

Application of unidirectional fibers in a direction parallel with the turbine periphery.

Proper selection of fiber

Proper selection of matrix or resin

Application of vacuum resin infusion techniques that minimize voids where crack propagation can initiate.

The blade material is not limited to composites. The blade material can be any material with elastic properties, or a somewhat rigid material for designs incorporating a rigid blade with spring like node. Materials such as spring steel, wood or polymers may be practical choices for some applications.

Two Stage Turbine Potential

Whereas conventional horizontal axis wind turbine systems have a single stage and single frontal sweep area, a vertical axis system has the potential of two times the frontal sweep area of a horizontal axis system. This is due to the fact that if the vertical axis turbine is large enough, the upwind half or semi cylinder of blades may be considered an independent stage while the same holds true for the downwind half or semi cylinder of blades. If large enough, the flow which has been slowed by the upstream blades has time to intermix with the surrounding kinetic energies of the flow field passing directly above and below the turbine to regain kinetic energy to a level substantially comparable to the original flow field velocity before passing the downstream blades. In theory, each of the two stages has the potential of approaching near the Betz limit thereby doubling the potential output based on the same value of frontal sweep area. Fluid dynamic effects involved with the flow field passing into the central area of the turbine may also contribute to output.

Potential for Increased Wind Farm Power Density

Public regulations require conventional horizontal axis wind turbines to be spaced a minimum of seven diameters in between turbines to reduce the potential destructive effects that turbulence can have on the blade of an adjacent turbine. For the inventive turbine, spacing may require significantly less space between turbines based on structural integrity of the turbine as a whole being extended to the periphery of the turbine, and the ability to also space turbines in an overlapping grid like fashion in the vertical direction. An example of stacking a vertical axis wind turbines upon a common axis can be seen in same inventor's patent on turbine structure.

Control of Start Up Speed

Blade design variables of the present invention can be tailored to meet practically any desired start up speed. Turbine diameter, blade elastic properties, blade thickness and distance from the center of effective blade area to the fixed end of blade are all design factors that control turbine start up speed. An increase in distance from the center of effective blade area to the fixed end of blade yields greater mechanical advantage for the flow field forces, allowing the blade to deflect and begin producing power at lesser approaching wind speeds. Increasing blade length implies moving the center of effective blade area to a greater distance from the fixed leading edge. The result is less required wind pressure for the same amount of blade deflection from the neutral position resulting in a lesser start up speed. Increasing turbine diameter also increases mechanical advantage by increasing the resulting value of d for the same amount of angular blade deflection. By decreasing blade thickness and or incorporating blade material with lesser resistance to flex, the amount of blade deflection can be increased for the same amount of flow field force applied to the blade. The start up speed for any new design can be tailored to start power production at significantly lesser flow field velocities than conventional designs such as horizontal axis propeller type turbines. The benefit of the present invention being the allowing for renewable energy to be available in areas previously thought of as impractical because of their lesser average wind speed. Again, it should be noted however that it becomes improper for the blade length to exceed ninety degrees of turbine periphery. In doing so, the resultant force vector may not pass on the correct side of turbine center, thus creating torque in the negative direction.

Horizontal axis turbines with propeller type blades require increasing the blade size, mass and structural strength to increase sweep area and potential power. The size, mass and structural strength for blades of the present invention can be independent of the applied turbine structure size.

The present invention does not require blade mechanics and is a turbine that can be characterized as a single component with flexible spring like components. The present blade is not based on airfoil lift but is based on the conventional physics of providing leverage to “molecule collisions” or “molecule deflection” and the resulting pressures of accumulated molecule deflection. The blades of the present invention are generally flat with the highest concentration of stresses at the leading edge of the blade, differing from conventional airfoil blades which have highest concentration of stresses at the location of aerodynamic center. Also, instead of camber, the blades of the present invention possess curvature that is ideally concentric to the turbine or system center when not deflected from the relaxed neutral position or in other words co-radial with the turbine periphery. The blades of the present invention possess deliberate flexibility that is critical to operation. The present invention achieves the objective of minimizing drag while optimally transferring imparted flow field kinetic energies to torque and rotation of the turbine. The blade of the present invention is essentially a cantilevered spring.

Society needs a turbine design that provides the means of which the wind turbine industry can survive and become self-sustaining. Today's wind turbines (or water turbines) are considered complex and require significant maintenance increasing the risk factors that can affect the return on investment.

The term “bigger is better” is well known in the wind turbine industry. Today's wind turbine designs are reaching engineering limitations decelerating the expanse to larger than eight megawatt systems for wind and lesser for underwater. The present invention proposes a system of lesser moving parts that is robust and has the potential of greater efficiencies than today's documented designs. Systems without complex blade actuation mechanics and with greater structural integrity have greater potential for achieving larger turbine capacity. Today's composite materials have significantly greater potential in combating material failure due to cyclic loading, fatigue or creep. While staying within a materials elastic range, the blade of the present invention has the potential to survive for many years or possibly near indefinite with minimum need for service. Also, as turbine size increases the frequency of blade cyclic loading decreases resulting in less cycles per unit of time thereby increasing system longevity. As society continues to pursue increasing the ratio of clean renewable energy use to that of fossil fuels, the present invention claims significant improvements to today's technology.

Used in conjunction with the inventor's previous turbine structure patent, the structural integrity of the system as a whole evenly distributes potential stresses and minimizes the potential wind loads imposed by the approaching wind resulting in the potential for significantly larger capacity systems with possible greater return on investment. The system as a whole requires less mass of construction materials per kilowatt hour of system capacity.

FIGS. 13D, 14 and 18 show a blade having a literal spring about the attachment node or blade turbine structure interface. Blade stiffness will affect resulting equilibrium rotational speed of the turbine. Advanced composites with controllable mechanical properties and excellent resilience and resistance to cyclic loading are considered ideal as a blade material.

The present invention can be used as an underwater turbine for extracting energy from underwater currents. The present invention has advantage in not requiring any external mechanism or algorithms or electronics to optimize blade orientation.

Comparison with Cyclogyro

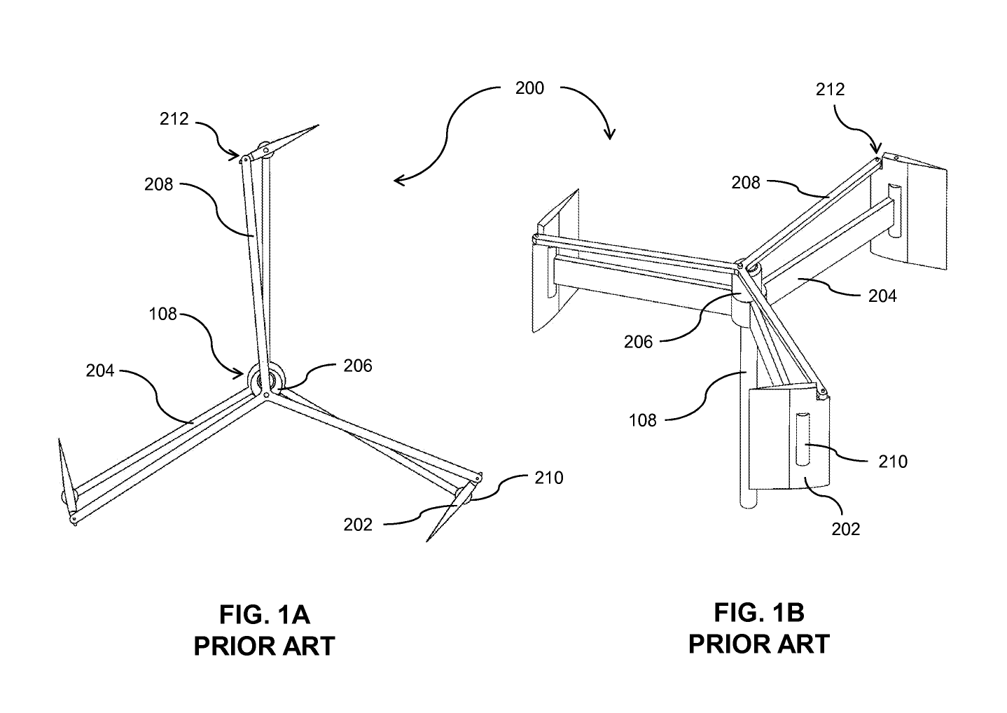

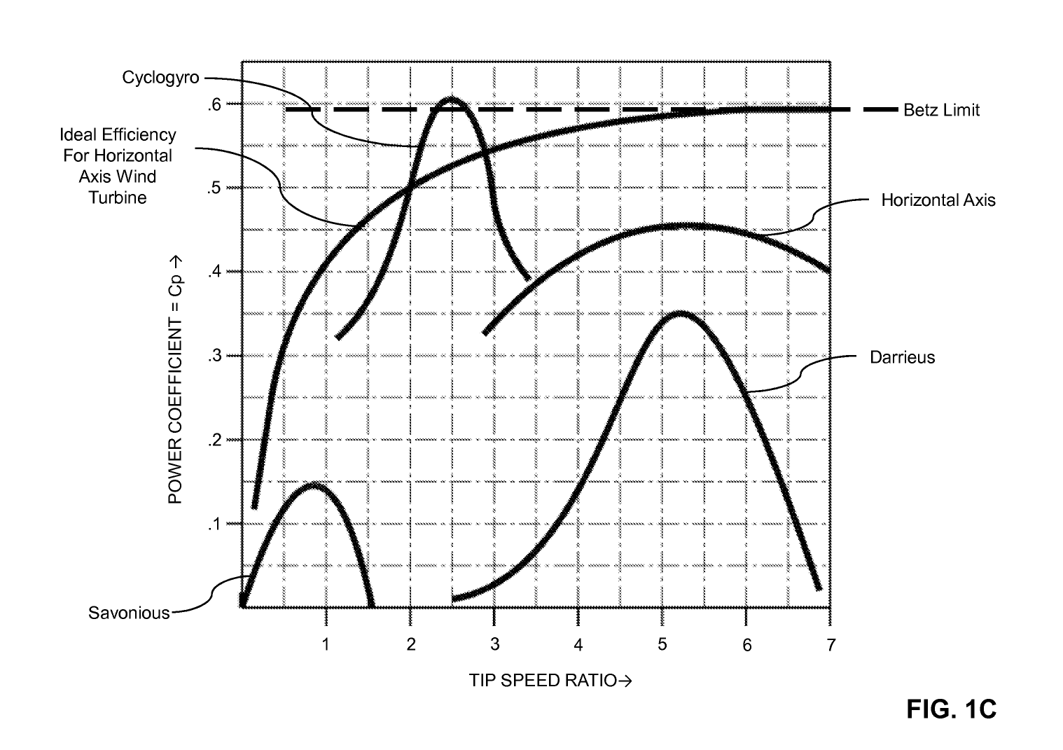

Referring to Prior Art FIGS. 1A-1C, the Cyclogyro wind turbine was invented by Jonathan Edward Caldwell in 1927. The Cyclogyro is a turbine with blades that are mechanically manipulated to improve performance.
A conventional Cyclogyro uses blades having a wing profile for producing airfoil lift, versus our new turbine that uses substantially flat blades that may be curved concentric with the turbine center.
At a given point in the rotational cycle of a cyclogyro, the angle of attack for all blades is changed by the same amount. Blade deflection for each blade of our new turbine changes independently while remaining in mechanical communication with other blades within the same turbine. Change of blade deflection at any particular point in the cycle dynamically self-adjusts according to flow field conditions exactly at the same location as the blade while at the same time considering the shared turbine speed with other blades. Therefore there are no proactive control or adjustment mechanisms.
The Cyclogyro uses a single cam mechanism located near the center axis of the turbine that must be oriented relative to the direction of the working flow field, for example by a wind directional vane. Our new turbine performs optimally without any need to control or adjust orientation or the like.
It is not possible for the blades of our new turbine to produce negative torque (opposed to the power generating positive torque). For the Cyclogyro, the blades do not adjust independently and where one blade may be positioned by the cam to an optimal position, the other blades lie in different locations on the turbine periphery and may produce significant drag depending on local deviations in working fluid forces.
   Whereas the Cyclogyro requires a mechanism such as a weathervane to control orientation relative to the wind, our new turbine differs by functioning on inherent natural adjustment. Blade reaction to any type of change in approaching wind direction will behave correctly regardless.

Comparison with Other Vertical Axis Turbine Systems

Many different vertical axis wind turbine systems exist with similarities in general configuration by possessing a plurality of blades equally spaced about the turbine central axis.
These other systems are found based on principals of aerodynamic wing lift.
These other systems are found to have their blade or wing interconnection with the supporting structure located at the blade or wing aerodynamic center approximately one third the cord length back from the leading edge and not at the leading edge.
These other systems are not based on producing torque through blade cantilevered deflection.
These other systems are not based on the reactions of oscillating internal resilience.

These other systems do not incorporate a blade of concentric curvature.

Although the invention has been illustrated and described in detail in the drawings and foregoing description, the same is to be considered as illustrative and not restrictive in character—it being understood that the embodiments shown and described have been selected as representative examples including presently preferred embodiments plus others indicative of the nature of changes and modifications that come within the spirit of the invention(s) being disclosed and within the scope of invention(s) as claimed in this and any other applications that incorporate relevant portions of the present disclosure for support of those claims. Undoubtedly, other “variations” based on the teachings set forth herein will occur to one having ordinary skill in the art to which the present invention most nearly pertains, and such variations are intended to be within the scope of the present disclosure and of any claims to invention supported by said disclosure.

What is claimed is:

1. A resilient blade turbine comprising:
a resilient structure comprising a circumferentially extended blade mounted at a leading edge to a periphery of a cylindrical turbine, and defining a neutral blade position;
wherein the resilient structure is configured to permit generally radial deflection of the blade in reaction to impinging fluid flow, and to resiliently oppose the deflection with a spring force biased to the neutral blade position.

2. The resilient blade turbine of claim 1 further comprising:
a resilient structure incorporates the resiliency in any combination of the blade, an attachment node where the blade is mounted, and the turbine carrier structure to which the blade is mounted,
resilient structure comprises a resilient spoke connected between the blade and a turbine hub;
resilient structure comprises a spring biased hinge
blade made resilient by being thin or tapered;
blade is curved to follow the turbine periphery in its neutral position
blade is planar and describes a chord of the periphery in its neutral position
a portion of the blade working surface is cut out to position effective area away from the fixed edge of a cantilever mounted blade.

3. The resilient blade turbine of claim 1 further comprising:
a pivot joint allowing multiple axis pivot of the entire turbine structure allowing adjustment of turbine sweep area and dynamic fluid flow through the center of the turbine for the purpose of optimizing the extraction of flow energy.
